(19) United States
(12) Patent Application Publication
(10) Pub. No.: US 2026/0306941 A1
(43) Pub. Date: Oct. 8, 2026

(54) VIRTUAL WORLD-BASED INFORMATION TRANSFER METHOD AND APPARATUS, DEVICE, AND MEDIUM

(71) Applicant: Tencent Technology (Shenzhen) Company Limited, Shenzhen (CN)

(72) Inventor: Boyuan Pan, Shenzhen (CN)

(21) Appl. No.: 19/181,446

(22) Filed: Apr. 17, 2025

Related U.S. Application Data
(63) Continuation of application No. PCT/CN2024/073831, filed on Jan. 24, 2024.

(30) Foreign Application Priority Data
Mar. 31, 2023 (CN) 2023103634690

(51) Int. Cl. A63F 13/352

(52) U.S. Cl. CPC A63F 13/352

(57) ABSTRACT

Aspects described herein relate to the field of human-computer interaction, and describe a virtual world-based information transfer method and apparatus, a device, and a medium. A server configured to deploy a virtual world may include at least two regional servers that are logically connected. The method may include generating, by a first regional server, at least one event signal of at least one event at a first computation time point, transmitting the at least one event signal to a second regional server at a second computation time point, receiving, by the second regional server, the at least one event signal, and computing, by the second regional server, the at least one event signal at a third computation time point, to obtain an event running result of each of the at least one event signal in the second regional server.

### RELATED APPLICATION

This application is a continuation application of PCT Application PCT/CN 2024/073831, filed Jan. 24, 2024, which claims priority to Chinese Patent Application No. 202310363469.0, filed on Mar. 31, 2023, each entitled “VIRTUAL WORLD-BASED INFORMATION TRANSFER METHOD AND APPARATUS, DEVICE, AND MEDIUM”, and each of which is incorporated herein by reference in its entirety.

### TECHNICAL FIELD

This application relates to the field of human-computer interaction, and in particular, to a virtual world-based information transfer method and apparatus, a device, and a medium.

### BACKGROUND

An online game may include a multiplayer online game using the Internet as a transmission medium and a game server as a processing terminal. With continuous development of network technologies, cloud technology-based virtual world products (for example, cloud games) are becoming increasingly abundant.

In a network game under a virtual world background in the related art, players are isolated in different regional servers. If cross-regional servers need to be implemented, information synchronization needs to be maintained between every two regional servers.

However, as a quantity of regional servers increases, a computation capability of one single regional server may reach an upper limit.

### BRIEF SUMMARY

Aspects described herein provide a virtual world-based information transfer method and apparatus, a device, and a medium. The technical solutions are as follows:

According to an aspect, a virtual world-based information transfer method is provided, where a server configured to deploy a virtual world includes at least two regional servers, and the at least two regional servers include a first regional server and a second regional server that are logically connected; and the method is performed by the first regional server and the second regional server, and the method includes:
generating, by the first regional server, at least one event signal of at least one event at a first computation time point;
transmitting, by the first regional server, the at least one event signal to the second regional server at a second computation time point, the second computation time point being a next computation time point following the first computation time point determined based on a first cycle, and the first cycle being a computation cycle corresponding to the first regional server;
receiving, by the second regional server, the at least one event signal; and
computing, by the second regional server, the at least one event signal at a third computation time point, to obtain an event running result of each of the at least one event signal in the second regional server, the third computation time point being a computation time point determined based on a second cycle, and the second cycle being a computation cycle corresponding to the second regional server.

According to another aspect, a virtual world-based information transfer method is provided, where a server configured to deploy a virtual world includes at least two regional servers, and the at least two regional servers include a first regional server and a second regional server that are logically connected; and the method is performed by the first regional server, and the method includes:
generating at least one event signal of at least one event at a first computation time point;
transmitting the at least one event signal to the second regional server at a second computation time point, the first computation time point and the second computation time point being adjacent computation time points determined based on a first cycle, and the first cycle being a computation cycle corresponding to the first regional server; and the at least one event signal being configured for being computed by the second regional server at a third computation time point after the at least one event signal is received by the second regional server, to obtain an event running result of each of the at least one event signal in the second regional server, the third computation time point being a computation time point determined based on a second cycle, and the second cycle being a computation cycle corresponding to the second regional server.

According to another aspect, a virtual world-based information transfer method is provided, where a server configured to deploy a virtual world includes at least two regional servers, and the at least two regional servers include a first regional server and a second regional server that are logically connected; and the method is performed by the second regional server, and the method includes:
receiving at least one event signal of at least one event; and
computing the at least one event signal at a third computation time point, to obtain an event running result of each of the at least one event signal in the second regional server, the third computation time point being a computation time point determined based on a second cycle, and the second cycle being a computation cycle corresponding to the second regional server;
the at least one event signal being generated by the first regional server at a first computation time point and transmitted to the second regional server at a second computation time point; and the first computation time point and the second computation time point being adjacent computation time points determined based on a first cycle, and the first cycle being a computation cycle corresponding to the first regional server.

According to another aspect, a virtual world-based information transfer apparatus is provided. The apparatus includes:
a processing module, configured to generate at least one event signal of at least one event at a first computation time point; and
a transceiver module, configured to transmit the at least one event signal to a second regional server at a second computation time point, the first computation time point and the second computation time point being adjacent computation time points determined based on a first cycle, and the first cycle being a computation cycle corresponding to the first regional server; and the at least one event signal being configured for being computed by the second regional server at a third computation time point after the at least one event signal is received by the second regional server, to obtain an event running result of each of the at least one event signal in the second regional server, the third computation time point is being a computation time point determined based on a second cycle, and the second cycle is being a computation cycle corresponding to the second regional server.

According to another aspect, a virtual world-based information transfer apparatus is provided. The apparatus includes:
a transceiver module, configured to receive at least one event signal of at least one event; and
a processing module, configured to compute the at least one event signal at a third computation time point, to obtain an event running result of each of the at least one event signal in a second regional server, the third computation time point being a computation time point determined based on a second cycle, and the second cycle being a computation cycle corresponding to the second regional server;
the at least one event signal being generated by the first regional server at a first computation time point and transmitted to the second regional server at a second computation time point; and the first computation time point and the second computation time point being adjacent computation time points determined based on a first cycle, and the first cycle being a computation cycle corresponding to the first regional server.

According to another aspect, a computer device is provided, including a processor and a memory, the memory having a computer program stored therein, the computer program being loaded and executed by the processor to implement the foregoing virtual world-based information transfer method.

According to another aspect, a computer-readable storage medium is provided, having a computer program stored thereon, the computer program being loaded and executed by a processor to implement the foregoing virtual world-based information transfer method.

According to another aspect, a computer program product is provided, including computer instructions, the computer instructions being stored in a computer-readable storage medium, and a processor obtaining the computer instructions from the computer-readable storage medium to load and execute the computer instructions to implement the foregoing virtual world-based information transfer method.

Aspects described herein provide at least the following beneficial effects:

According to aspects described herein, the server configured to deploy the virtual world may include the at least two regional servers, and the at least two regional servers may include a first regional server and a second regional server that are logically connected. The first regional server may generate the at least one event signal of the at least one event at the first computation time point; and the first regional server may transmit the at least one event signal to the second regional server at the second computation time point. The second computation time point may be the next computation time point following the first computation time point determined based on the first cycle, and the first cycle may be the computation cycle corresponding to the first regional server. The second regional server may receive the at least one event signal; and the second regional server may compute the at least one event signal at the third computation time point, to obtain the event running result of each of the at least one event signal in the second regional server. The third computation time point may be the computation time point determined based on the second cycle, and the second cycle may be the computation cycle corresponding to the second regional server. According to methods and processes described herein, for a regional server, the regional server might only need to maintain data and a cycle of the regional server without a need for caring about data of another regional server and without a need for synchronizing the data of the another regional server. For an event occurring in the another regional server, an event signal may be computed only when the event signal of the event can be transferred to the regional server and the event signal has already been transferred to the regional server, so that the event signal participates in running of the regional server. According to this, the methods and processes described herein may be applied to a cloud technology scenario such as a cloud game, and may implement expansion of a quantity of regional servers of a game without being limited by computational capabilities of the regional servers, so that boundlessness and infinity of the game is implemented, to construct a boundless and infinite cloud game world and further provide a new game world view.

### BRIEF DESCRIPTION OF THE DRAWINGS

FIG. 1 is a block diagram of an example structure of a computer system according to one or more aspects described herein.

FIG. 2 is a schematic diagram of a game running mechanism according to one or more aspects described herein.

FIG. 3 is a schematic diagram of a virtual world-based information transfer method according to one or more aspects described herein.

FIG. 4 is a schematic diagram of a server configured to deploy a virtual world according to one or more aspects described herein.

FIG. 5 is a schematic diagram of a shared storage region according to one or more aspects described herein.

FIG. 6 is a schematic diagram of a virtual world-based information transfer method according to one or more aspects described herein.

FIG. 7 is a schematic diagram of a server configured to deploy a virtual world according to one or more aspects described herein.

FIG. 8 is a schematic diagram of a virtual world-based information transfer method according to one or more aspects described herein.

FIG. 9 is a schematic diagram of a virtual world-based information transfer method according to one or more aspects described herein.

FIG. 10 is a schematic diagram of a virtual world-based information transfer method according to one or more aspects described herein.

FIG. 11 is a flowchart of a virtual world-based information transfer method according to one or more aspects described herein.

FIG. 12 is a flowchart of a virtual world-based information transfer method according to one or more aspects described herein.

FIG. 13 is a flowchart of a virtual world-based information transfer method according to one or more aspects described herein.

FIG. 14 is a flowchart of a virtual world-based information transfer method according to one or more aspects described herein.

FIG. 15 is a flowchart of a virtual world-based information transfer method according to one or more aspects described herein.

FIG. 16 is a block diagram of a structure of a virtual world-based information transfer apparatus according to one or more aspects described herein.

FIG. 17 is a block diagram of a structure of a virtual world-based information transfer apparatus according to one or more aspects described herein.

FIG. 18 is a block diagram of a structure of a computer device according to one or more aspects described herein.

### DETAILED DESCRIPTION

Game: May also be referred to as an online game, and may include a multiplayer online game using the Internet as a transmission medium and a server as a processing terminal. The game provided in aspects herein may be based on a principle of special relativity in modern physics, abandoning a game world view in the related art. A basic principle of the game world view according to aspects described herein may be as follows:
Time relativity and local inertial reference frame: In the related art, each server (referred to as a regional server in this arrangement) in the game has a global clock (referred to as a virtual time zone in this arrangement). Clocks of regional servers may need to be synchronized, similar to absolute time in classical mechanics. However, in a new game world view, there might not be a need to maintain a globally unified clock. Instead, each independent regional server in the game may use the regional server as a local inertial reference frame to maintain its own clock. For example, a regional server 1 maintains its own clock 1, and the clock 1 may be a 24-hour system; a regional server 2 maintains its own clock 2, and the clock 2 is a 48-hour system; and the clock 1 and the clock 2 are different clocks.
Principle of constant speed of light: In the related art, time taken for information transfer is treated as a delay in the game, and is not used as a process of the game. It is assumed in game logic that a speed of information transfer is infinite. However, the special relativity points out that a light speed has an upper limit, meaning that the speed of information transfer is finite. In the new game world view, an information transfer process is also a part of the game. For example, if a player travels from a regional server 1 to a regional server 2, a traveling process is also a part of the game.

Virtual world: May refer to a virtual world displayed or provided during running of a client corresponding to the game provided in this arrangement. The virtual world may be a simulated environment of the real world, a semi-simulated and semi-fictional environment, or a completely fictional environment. The virtual world may be any one of a two-dimensional virtual world, a two-and-a-half-dimensional virtual world, and a three-dimensional virtual world.

Virtual object: May refer to a movable object in a virtual environment. The movable object may be at least one of a virtual character, a virtual animal, and a cartoon character. According to one or more aspects, when the virtual environment is a three-dimensional virtual environment, the virtual object may be a three-dimensional virtual model. Each virtual object has its own shape and volume in the three-dimensional virtual environment, and occupies a part of space in the three-dimensional virtual environment. In some examples, the virtual object is a three-dimensional character built based on a three-dimensional human skeleton technology. The virtual object achieves different external figures by wearing different skins. In some arrangements, the virtual object may alternatively be implemented by using a two-and-a-half-dimensional or a two-dimensional model. The virtual objects are not limited to these examples.

Virtual element: May refer to and include various elements appearing in the virtual world, configured to form the entire virtual world. The virtual element may include a plot, a lake, the sky, various virtual animals, various virtual plants, various virtual buildings, various virtual items, and the like. A virtual object controlled by a player may also be one of the virtual elements.

Regional server: May also be referred to as a server or a node. One regional server may be carried by one server or one server cluster. In such arrangements, a server configured to deploy the virtual world may include at least two regional servers. The regional servers might not be directly connected to each other, but may be logically connected to each other by using a message forwarding node (or referred to as an information transfer node). Each regional server might only be able to transfer information to another regional server that is logically connected to the regional server, but might not be able to transfer information to another regional server that is not logically connected to the regional server.

In an example, a virtual world of an entire game is considered as (e.g., analogized to) a ball (where reference may be made to a shape of a soccer ball), and a server configured to deploy the virtual world includes at least two regional servers. A virtual sub-world (where reference may be made to each pentagonal region on the soccer ball) corresponding to each regional server is distributed on a surface of the virtual world. Each regional server extends outward, and is communicatively connected to a limited quantity of other regional servers by using the message forwarding node. There is an information transfer path between each regional server or the message forwarding node and N regional servers close to a boundary of the regional server. In other words, there is a signal line connected in the physical world, allowing the regional server or the message forwarding node and the N regional servers to transmit and receive information from each other.

The server according to aspects described herein may be an independent physical server, a server cluster or distributed system including a plurality of physical servers, or may be a cloud server providing basic cloud computing services, such as a cloud service, a cloud database, cloud computing, a cloud function, cloud storage, cloud communication, a middleware service, a domain name service, a security service, a content delivery network (CDN), and a big data and artificial intelligence platform. In addition, a terminal may be a smart phone, a tablet computer, a notebook computer, a desktop computer, a smart speaker, a smartwatch, or the like, but is not limited thereto. The terminal and the server may be directly or indirectly connected in a wired or wireless communication manner, which is not limited herein.

Event: May refer to a basic unit for running the virtual world of the entire game. Analogous to descriptions of the event in relativity, due to the time relativity in various arrangements, it cannot be said that an event occurs at a place, but instead an event occurs at a place and time in an inertial reference frame. In other words, the event always occurs at selected [x, y, z, t], where x, y, and z are values in horizontal coordinate, vertical coordinate, and depth coordinate directions in the inertial reference frame, and t is the time in the inertial reference frame. Similarly, the event in the virtual world in such arrangements is also described by an event attribute (what event, represented as what) of the event, a regional server (which inertial reference frame, represented as which) in which the event is located, a logical position (a spatial position in a selected inertial reference frame, represented as where) in the regional server, and a generation moment (a generation time in the selected inertial reference frame, represented as when) in the regional server. Therefore, an event description vector corresponding to the event in such examples may need to include at least the foregoing four types of information, and at least the following event description vector is needed for description: [what, which, where, when].

Similarly, the virtual element in the game according to aspects described herein may alternatively be abstracted as an event: what virtual element, which regional server the virtual element is located in, a logical position in the regional server, and a generation moment in the regional server. The only difference from the event is that the virtual element is finally rendered in the virtual world of the game in this arrangement, and can be seen by a user. In such examples, the event and the virtual element may be mutually converted and interact with each other. The event may generate a virtual element, and the virtual element may also generate an event. Similar to a relationship between mass and energy in modern physics, the event is more like the energy, and the virtual element is more like the mass. In one example, the event corresponds to at least one of virtual energy and virtual mass.

Spreading event: May refer to a type of the event, and may include an event including at least two propagation directions. The spreading event includes virtual energy and does not include virtual mass. The spreading event may be transmitted from a regional server to all regional server logically connected to the regional server, and the virtual energy of the spreading event attenuates with a propagation distance. If attenuation does not occur, the spreading event continues to propagate indefinitely in the virtual world of the game and will never disappear. When the regional server computes the same spreading event transferred from different regional servers to the regional server at the same time, corresponding virtual energy of the spreading event in the regional server may be accumulated. For example, the spreading event may be an event that needs to be broadcast or notified, for example, a player obtains a reward, or a player wins a competition champion.

Unidirectional transfer event: May refer to a type of the event, and is an event in which a single propagation direction and a termination condition are set. The unidirectional transfer event includes virtual energy and virtual mass. In an example, the virtual energy of the unidirectional transfer event attenuates with a propagation distance, and the virtual mass keeps unchanged. When the regional server computes the same unidirectional transfer event transferred from different regional servers to the regional server at the same time, corresponding virtual energy of the unidirectional transfer event in the regional server may be accumulated. In one arrangement, the termination condition of the unidirectional transfer event includes at least one of reaching a set quantity of times of propagation, the virtual energy being less than an energy threshold, the event reaching a specified regional server, and there being no valid propagation direction for continuing propagation. For example, the unidirectional transfer event may be: a cross-regional-server traveling event in which a player travels from a regional server to another regional server, a same-regional server traveling event in which a player travels from a computation unit to another computation unit in the same regional server, a cross-regional-server flight event in which a virtual item flies from a regional server to another regional server, or a same-regional server flight event in which a virtual item flies from a computation unit to another computation unit in the same regional server.

Computation unit: May refer to a plurality of units divided in a regional server, and one regional server may include at least two computation units. The computation unit is similar to a plurality of parallel computing cores inside a graphics processing unit (GPU). All events occurring in the same computation cycle in computation units in the same regional server occur at the same time but in different places. In a computation unit, it may be considered that all events in the same computation cycle occur at the same time and in the same place. According to this definition, because a distance is close, an effect of relativity may be ignored, reverting to classical mechanics. In other words, in the same regional server, all virtual elements and events may still directly run according to the same clock and computation cycle in the related art.

Shared storage region: May refer to a storage region shared by at least two computation units in the same regional server. One regional server corresponds to one shared storage region, and each computation unit in the regional server corresponds to a sub-region in the shared storage region. Computation units in the same regional server no longer transfer information between each other through a signal line but through the shared storage region. For example, a regional server includes a computation unit 1 and a computation unit 2. The regional server corresponds to a shared storage region, the computation unit 1 corresponds to a region 1 in the shared storage region, and the computation unit 2 corresponds to a region 2 in the shared storage region. The computation unit 1 may access the region 1 and the region 2 in the shared storage region, and the computation unit 2 may also access the region 1 and the region 2 in the shared storage region.

Cloud technology: May refer to a hosting technology that integrates resources, such as hardware, software and networks, to implement data computing, storage, processing, and sharing in a wide area network or local area network.

The cloud technology may be a general term of network technologies, information technologies, integration technologies, management platform technologies, application technologies, and other technologies applied to a cloud computing business model, and creates a resource pool to satisfy what is needed in a flexible and convenient manner. A cloud computing technology is to be the backbone. A lot of computing resources and storage resources are needed for background services in a technical network system, such as video websites, picture websites and other portal websites. With advanced development and application of the internet industry, each object is likely to have a recognition flag. These flags need to be transmitted to a background system for logical processing, and data at different levels may be processed separately. Therefore, data processing in all industries requires a strong system to support, and is implemented only through cloud computing technologies.

Cloud gaming: May also be referred to as gaming on demand, and may refer to an online gaming technology based on a cloud computing technology. The cloud gaming technology enables a thin client having limited graphic processing and data computing capabilities to run a high-quality game. In a cloud game scenario, a game is not run on a player game terminal, but is run on a cloud server, and the cloud server renders a game scene into a video and audio stream, and transmits the video and audio stream to the player game terminal over a network. The player game terminal might not need to have a strong graphic computing and data processing capability, and might only need to have a basic streaming media play capability and a capability of obtaining a player input instruction and transmitting the player input instruction to the cloud server.

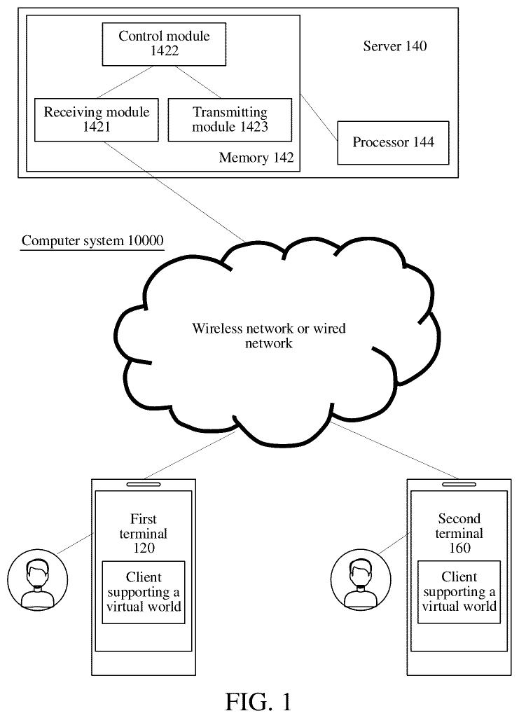

FIG. 1 is a block diagram of an example structure of a computer system according to one or more aspects described herein. The computer system may be a system architecture for implementing a virtual world-based information transfer method. The computer system 100 includes: a first terminal 120, a server 140, and a second terminal 160.

A client that provides support for a virtual world may be installed and run on the first terminal 120. For example, the client may be any one of a battle royale shooting game, a virtual reality (VR) client, an augmented reality (AP) program, a three-dimensional map program, a virtual reality game, an augmented reality game, a first-person shooting game (FPS), a third-personal shooting game (TPS), a multiplayer online battle arena game (MOBA), and a simulation game (SLG).

The first terminal 120 may be a terminal used by a first user. The first user may use the first terminal 120 to control a first virtual object located in the virtual world. This control may include but is not limited to: at least one of adjusting a body posture, crawling, walking, running, riding, jumping, driving, picking up, shooting, attacking, throwing, building a virtual building, and traveling to a virtual sub-world corresponding to another server.

The first terminal 120 may be connected to the server 140 over a wireless network or a wired network.

The server 140 may be an independent physical server, a server cluster or distributed system including a plurality of physical servers, and a cloud server providing basic cloud computing services, such as a cloud service, a cloud database, cloud computing, a cloud function, cloud storage, cloud communication, a middleware service, a domain name service, a security service, a content delivery network (CDN), and a big data and artificial intelligence platform. The server 140 includes at least one of a server, a plurality of servers, a cloud computing platform, and a virtualization center.

For example, the server 140 may include a processor 144 and a memory 142. The memory 142 further includes a receiving module 1421, a control module 1422, and a transmitting module 1423. The receiving module 1421 may be configured to receive a request transmitted by a client, such as a first viewing request about viewing an equipment or a second viewing request about viewing a location. The control module 1422 may be configured to control rendering of a virtual world picture. The transmitting module 1423 may be configured to transmit a response to the client, for example, transmit a current existing equipment to the client, or transmit a current location to the client. The server 140 may be configured to provide a background service for clients of the first terminal 120 and the second terminal 160.

In one arrangement, the server 140 may undertake main computing work, and the first terminal 120 and the second terminal 160 may undertake secondary computing work. Alternatively, the server 140 undertakes secondary computing work, and the first terminal 120 and the second terminal 160 undertake main computing work. Alternatively, the server 140, the first terminal 120, and the second terminal 160 may perform collaborative computing by using a distributed computing architecture. In this arrangement, the server 140 may also be referred to as a regional server. A server configured to deploy the virtual world may include a plurality of servers 140 of the same model or different models. A complete virtual world may include a plurality of virtual sub-worlds, one virtual sub-world is deployed on one server 140, and one server 140 may be connected to different terminals. For example, the server 140 may be connected to the first terminal 120 and the second terminal 160. To be specific, the first user and a second user may be located in the same regional server, and the virtual sub-world corresponding to the server 140 may be displayed on both the clients of the first terminal 120 and the second terminal 160 A plurality of servers configured to deploy the virtual world in this arrangement respectively correspond to different virtual time zones (where clocks are not synchronized). A quantity of the servers may continuously increase, and the virtual world may continuously expand. Therefore, the virtual world in this arrangement might not have a complete world map, and a virtual sub-world corresponding to each server 140 may have a complete sub-world map. The virtual time zone described herein might only be configured for indicating that clocks in different regional servers are not synchronized, and a globally consistent clock of each regional server might not need to be maintained. However, no restrictive regulation is made on a difference between the clocks in the regional servers, and a difference in virtual time zones in the different regional servers is usually random.

A client supporting the virtual world may be installed and run on the second terminal 160. The client may be any one of a battle royale shooting game, a virtual reality (VR) client, an augmented reality (AP) program, a three-dimensional map program, a virtual reality game, an augmented reality game, a first-person shooting game (FPS), a third-personal shooting game (TPS), a multiplayer online battle arena game (MOBA), and a simulation game (SLG). The second terminal 160 may be a terminal used by the second user. The second user may use the second terminal 160 to control a second virtual object located in the virtual world. This control may include but is not limited to: at least one of adjusting a body posture, crawling, walking, running, riding, jumping, driving, picking up, shooting, attacking, throwing, building a virtual building, and traveling to a virtual sub-world corresponding to another server.

In one arrangement, a virtual object controlled by the first user by using the first terminal 120 and a virtual object controlled by the second user by using the second terminal 160 may be located at different locations in the same virtual world. In other words, the first user and the second user are in the same battle in the same virtual world.

In one arrangement, the clients installed on the first terminal 120 and the second terminal 160 may be the same, or the clients installed on the two terminals may be the same type of client on different control system platforms. Forms of the clients installed on the first terminal 120 and the second terminal 160 are not limited in arrangements described herein, and may include but are not limited to: applications (Apps), mini programs, and the like installed on the first terminal 120 and the second terminal 160, or may be in a form of a web page. The first terminal 120 may generally be one of a plurality of terminals, and the second terminal 160 may generally be another of the plurality of terminals. This arrangement only uses the first terminal 120 and the second terminal 160 as examples. Device types of the first terminal 120 and the second terminal 160 may be the same, and device models may be different. The device type may include at least one of a smart phone, a tablet computer, a wearable device, a personal computer (PC), a laptop portable computer, and a desktop computer. An example in which the terminal includes a smart phone is used for description in the following arrangements. A person skilled in the art may know that there may be more or fewer terminals. For example, there may be only one terminal (to be specific, a user battles against artificial intelligence), or there may be eight terminals (1v1v1v1v1v1v1v1, where eight users compete in a round-robin and elimination format, ultimately determining the winner), or there may be more terminals. A quantity of the terminals and the device type are not limited in arrangements described herein.

In the related art, in an online game, players may be essentially isolated in different regional servers. Due to limited computation capabilities of the regional servers, it may be impossible to place all players on the same server. However, in the online game, there may be a need for interaction between players across regional servers. If a cross-regional-server event (for example, a plurality of players are teamed across regional servers, or achievement information in one regional server is broadcast to a plurality of regional servers) needs to be implemented, it may be necessary to maintain a pairwise connection and information synchronization between the regional servers. Therefore, a quantity of connections on a single regional server might necessarily increase at a speed of O(n) as a quantity of regional servers increases, and a total quantity of connections on all regional servers might necessarily increase at a speed of O(n²) as the quantity of the regional servers increases. Each time a new regional server is added, another existing regional server might need to establish a connection and synchronize information to achieve information synchronization. As the quantity of the regional servers increases, a quantity of connections on each regional server increases, and information synchronization pressure increases, a computation capability of the regional server inevitably reaches an upper limit. Consequently, the quantity of the regional servers cannot be increased any more. It can be learned that a game in the related art cannot be boundless and infinite.

To be specific, a basic game running mechanism in the related art may be to render all virtual elements in a current virtual scene of a virtual world of the game within an interval of one frame, and the virtual elements may be affected by an event. Consequently, as a quantity of the virtual elements and a quantity of events in the virtual scene increase, a computation capability of a computer inevitably reaches an upper limit. This may directly cause a size of the virtual scene of the game and a total quantity of elements in the virtual scene to be limited.

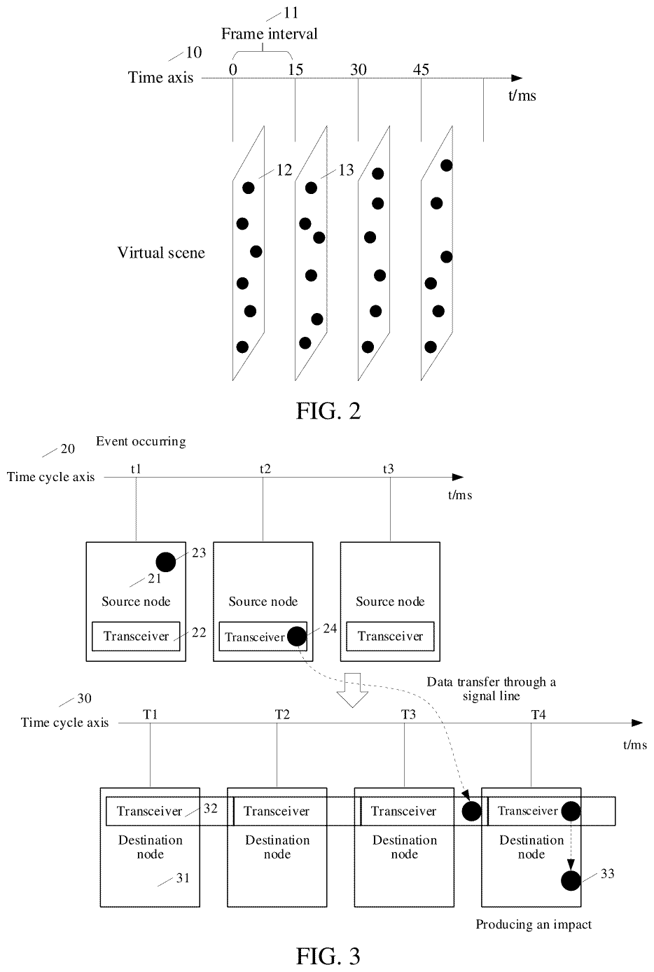

Generally, the foregoing game running mechanism may depend on two assumptions, namely, absolute time and an infinitely fast information transfer speed, and may require that all the virtual elements and events in the game need to simultaneously advance a game process according to a unified clock. FIG. 2 is a schematic diagram of an example game running mechanism according to one or more aspects described herein. In a game, a unified time axis 10 is included, and a frame interval 11 is 16 ms. All virtual elements and events in the game might need to simultaneously advance a game process according to the unified frame interval 11. For example, in the 1^{st} frame interval 11 (0 s to 15 ms), an image frame 12 is rendered and displayed, and in the 2^{nd} frame spacing 11 (15 s to 30 s), an image frame 13 is rendered and displayed. In addition, when the game is run in each frame, it is attempted to obtain all virtual elements and events in a virtual scene of the game that is running at this moment and complete computing. The game running mechanism may be based on a concept of space-time in classical mechanics.

Different from the space-time in classical mechanics, according to a principle of relativity, an event occurring in distant galaxies at this moment are outside a light cone of an observer on the earth at this moment, and only affects the observer on the earth after light reaches the earth (by which time the observer will be in the future).

Different from the game running mechanism in the related art, the principle of relativity is introduced into a grand game world picture. A result of an upper limit of an information transfer speed is that an event occurring at a logically sufficient distance at this moment cannot affect a game element at this moment and in this place. In other words, at each moment, an event in a distant game scene does not need to be considered in computing of a local game scene, even if the distant game scene is currently running and an event that may affect another region occurs. Admitting the upper limit of the information transfer speed and discarding global absolute time may remove limitations of the computation capability of the computer to the game.

Based on this guidance idea, the following game mechanisms may be established in this arrangement:
An entire grand game may be divided into nodes that are separated in logical space (for example, a plurality of regional servers are provided for the game, the virtual world of the game is divided into a plurality of virtual sub-worlds, and each regional server corresponds to one virtual sub-world).
Clocks in the nodes may work independently and uniformly, similar to a local inertial frame, and output may be computed frame by frame in the nodes according to a classical game computation method.
Clocks between the nodes might not need to be synchronized (or a clock is selected to be shared by the nodes), and event communication may be performed between only logically connected nodes. Transfer of an event may occupy at least one frame interval of a node. In one computation, the node might only need to process event signals of a limited quantity of events, which can prevent the node from reaching an upper limit of a computation capacity.
The events and the virtual elements of the game may cross to logically adjacent nodes. Therefore, a player in the game might only be in one node at the same moment, but may still consume time to move to another node to explore the entire virtual world of the game, so that the player can smoothly experience the grand game, only needing to spend time moving when crossing a large virtual distance to switch between regional servers.

### Manner of Information Transfer Between Nodes With Unsynchronized Clocks

The nodes with the unsynchronized clocks may be similar to a relationship between distant planets in the universe, and correspond to two computer devices (servers) connected via a communication line in the computer world. Clock cycles (computation cycles) of hardware of the nodes might not be unsynchronized, and even clock frequencies may be different.

FIG. 3 is a schematic diagram of a virtual world-based information transfer method according to one or more aspects described herein. A source node 21 (corresponding to the first regional server in the foregoing arrangements) is included. The source node 21 may include a transceiver 22, and the source node 21 corresponds to a time cycle axis 20 (corresponding to the first cycle in the foregoing arrangements). A destination node 31 (corresponding to the second regional server in the foregoing arrangements) may be included. The destination node 31 includes a transceiver 32, and the destination node 31 corresponds to a time cycle axis 30 (corresponding to the second cycle in the foregoing arrangements).

In one arrangement, receiving of the transceiver 22 and the transceiver 32 operates independently through a receiving module, and transmitting operates independently through a transmitting module. The transmitting module and the source node 21 work in the same cycle, and the receiving module works in a terminal manner. The transceiver 22 and the transceiver 32 may correspond to network interface card devices in a modern computer, and work according to a clock cycle during transmitting, and are in an interrupt mode during receiving.

For example, the source node 21 may generate an event 23 that is to be transferred to the destination node 31 at a moment t1. Although the event 23 is about to affect the destination node 31, running in the destination node 31 might not be affected by the event until the event 23 reaches the destination node 31 and participates in the running. There is no need to synchronize information of the two nodes, and the destination node 31 might only need to process the event 23 affecting the destination node 31.

There may be two transmitting manners for the event 23 generated at the moment t1: 1. The source node 21 hands over, at the moment t1 when the event 23 occurs, the event 23 to the transceiver 22 for transmitting. An advantage of this manner may be that the event 23 is transmitted more quickly. A disadvantage may be that a working moment of the transceiver 22 needs to be fixed at a final stage of current computation, and the source node 21 needs to end the computation only after all transmitting of the transceiver 22 is completed. 2. Only an event signal of the event 23 may be delivered to a queue of the transceiver 22 at the moment t1, and the transceiver 22 may deliver all event signals at a next computation time point, that is, a moment t2.

The source node 21 may start to transmit an event signal 24 of the event 23 to the destination node 31 through a signal line at the moment t2. Assuming that the event signal 24 reaches the destination node 31 between a moment T3 and a moment T4 of the destination node 31, because the transceiver 32 may be in an interrupt working mode, the transceiver 32 may notify the destination node 31 to store the received event signal 24 for processing in a next computation cycle. To be specific, after the destination node 31 receives the event signal 24, the event signal 24 may start to participate in running of the destination node 31 at the moment T4, to start to affect the destination node 31. After the event 23 is computed in the destination node 31, the event 23 may be changed into an event 33.

Time consumption of a transfer process from the source node 21 to the destination node 31 may derive from time consumption of information processing of hardware and time consumption of signal transfer on the signal line, and might not be able to be eliminated. Regardless of hardware optimization, this time consumption may always be higher than time consumption of transfer of an electromagnetic wave between two physical devices in a vacuum in the real world.

Operations of the foregoing process are summarized as follows:
1. The source node 21 generates an event a at a moment t(m) of the time cycle axis 20. If the event a is an event that can be transmitted to another node, the event a is delivered, during current computation, to the transceiver 22 of the source node 21 to wait to be transmitted.
2. The source node 21 transmits an event signal of the event a to the destination node 31 through the signal line at a moment t(m+1) following the moment t(m).
3. The transceiver 32 of the destination node 31 receives the event signal at a moment T(x) of the destination node 31, where T(x) is located between a moment T(n) and a moment T(n+1) on the time cycle axis 30 of the destination node 31.
4. Because a current local event computation at T(n) is already in progress, the transceiver 32 of the destination node 31 can only transmit an interrupt signal to require the destination node 31 to process the event signal at the next moment T(n+1), so that the event a participates in game running of the destination node 31.
5. So far, transfer of the event is completed.

It can be learned from the foregoing process that a distant event finally affects game running, but does not immediately affect the game running at this time and in this place. No matter how a quantity of nodes increases, each node needs to process only limited quantities of virtual elements and events in one game computation, that is, virtual elements and events inside the node and a limited quantity of events in the transceiver. According to a basic principle of modern physics, in one or more arrangements, an infinite and boundless game world model based on existing hardware facilities may be constructed.

### Manner of Information Transfer Between Computation Units Inside Nodes With Synchronized Clocks

A relationship between the computation units inside the nodes with the synchronized clocks may be similar to a relationship between two places that are far away from each other and that are inside the same planet. All the computation units may be approximately the same inertial frame, but there may be a distance between the computation units. In comparison with the physical world, that is, a plurality of cores running in parallel on the same server, the computation units may be closer to a structure of a modern GPU, and all cores may work at the same clock frequency and in the same cycle.

All events occurring in the same clock cycle in computation units within the same node occur at the same time but in different places. However, in a computation unit, it may be considered that all events in the same clock cycle at the same time and in the same place. According to this definition, because a distance is close, an effect of relativity may be ignored, reverting to classical mechanics. In other words, in the same computation unit, all virtual elements and events of a game may still be directly run in an existing manner.

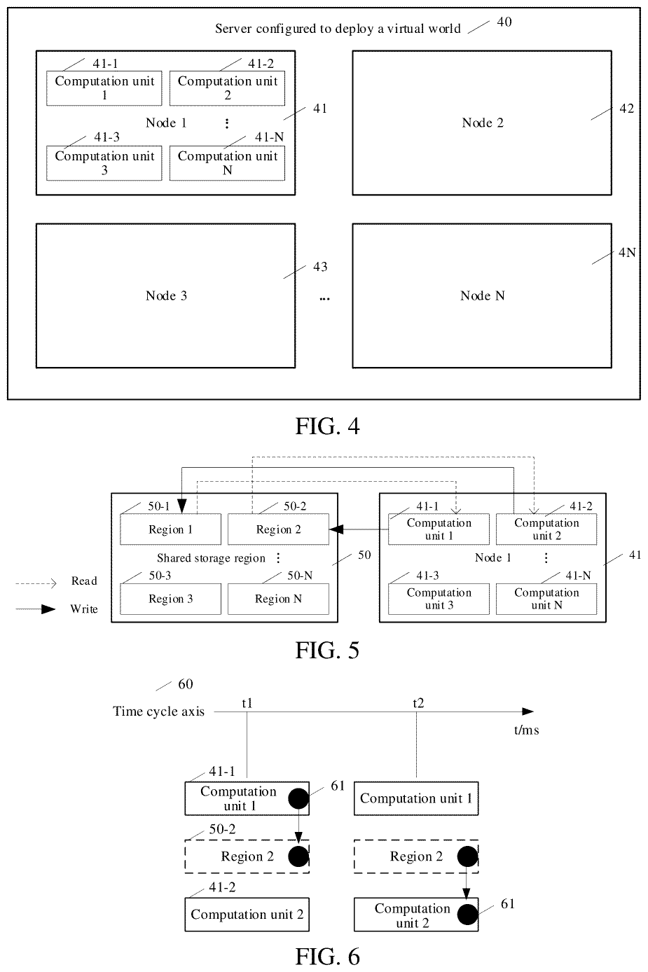

FIG. 4 is a schematic diagram of an example server configured to deploy a virtual world according to one or more aspects described herein. The server 40 may be configured to deploy the virtual world includes N nodes (corresponding to the regional servers in the foregoing arrangements), for example, a node 1 (41), a node 2 (42), a node 3 (43), and a node N (4N). Using the node 1 (41) as an example, the node 1 (41) includes N computation units, for example, a computation unit 1 (41-1), a computation unit 2 (41-2), a computation unit 3 (41-3), and a computation unit N (41-N).

It can be learned that a logical distance between computation units may be much shorter than a logical distance between nodes. Correspondingly, a speed of event transfer between the computation units may also be much faster than a speed of event transfer between the nodes. Similar to a distant event on the same planet, the event can more quickly affect the planet here than an event on a distant planet. Still similar to the plurality of parallel computing cores in the GPU, information might not be transferred between the computation units through a signal line, but through a shared storage region.

FIG. 5 is a schematic diagram of an example shared storage region according to one or more aspects described herein. In the figure, a dashed-line arrow indicates reading, a solid-line arrow indicates writing, and each computation unit corresponds to a sub-region in the shared storage region. For example, a node 1 (41) corresponds to a shared storage region 50, a computation unit 1 (41-1) corresponds to a sub-region 1 (50-1) in the shared storage region 50, a computation unit 2 (41-2) corresponds to a sub-region 2 (50-2) in the shared storage region 50, a computation unit 3 (41-3) corresponds to a sub-region 3 (50-3) in the shared storage region 50, and a computation unit N (41-N) corresponds to a sub-region N (50-N) in the shared storage region 50.

Specifically, each computation unit may correspond to a sub-region in the shared storage region, and each computation unit may read an event signal from the sub-region corresponding to the computation unit. In addition, logically adjacent computation units may write an event signal of an event into a sub-region of each other. In this way, it can be ensured that the logically adjacent computation units can efficiently receive and transmit information to each other.

FIG. 6 is a schematic diagram of an example virtual world-based information transfer method according to one or more aspects described herein. A time cycle axis 60 of a node 1 (41), a computation unit 1 (41-1) (corresponding to the first computation unit in the foregoing arrangements), a computation unit 2 (41-2) (corresponding to the second computation unit in the foregoing arrangements), and a sub-region 2 (50-2) corresponding to the computation unit 2 (41-2) in a shared storage region may be included. The computation unit 1 (41-1) and the computation unit 2 (41-2) may be logically directly connected. At a moment t1, the computation unit 1 (41-1) may generate an event to be transferred to the computation unit 2 (41-2), and the computation unit 1 (41-1) may write an event signal (61) of the event into the sub-region 2 (50-2) during current computation. Due to the same time but different places, the computation unit 2 (41-2) might not be affected by the event at the moment t1. At a next moment t2, the computation unit 2 (41-2) may read the event signal (61) of the event from the sub-region 2 (50-2) and allow the event to participate in running. In other words, from the moment t2, the event may start to affect the computation unit 2 (41-2). From a perspective of a single event, a computation unit receiving the event may read the event and compute the event only at a next moment. When a game continuously runs, the computation unit may continuously read, in each computation cycle, an event written by another unit into a corresponding shared storage region in a previous computation cycle. It can be learned that time consumption of event transfer between computation units may be permanently fixed as a common clock cycle of the computation units. In other words, a speed of transfer between the computation units may be determined by an operating frequency of a hardware device carrying the computation units.

Operations of the foregoing process are summarized as follows:
1. A source computation unit (corresponding to the foregoing computation unit 1) generates an event a at a moment t(n) of a clock cycle. If the event a is an event that may be transmitted to another computation unit, during current computation, an event signal corresponding to the event a is written into a sub-region of a shared storage region corresponding to a destination computation unit (corresponding to the foregoing computation unit 2).
2. The destination computation unit reads the event signal of the event a from the sub-region of the shared storage region at a next moment t(n+1) of the clock cycle and allows the event a to participate in game running. 3. So far, transfer of the event is completed.

It can be learned from the foregoing process that an event from a computation unit that is logically adjacent may affect game running in a current computation unit at a next moment. In comparison with event transfer between the nodes with the unsynchronized clocks, this manner may be more efficient, and may be applicable to interaction between parts in a game running on the same server.

Next, the foregoing game mechanism that introduces the principle of relativity is further described.

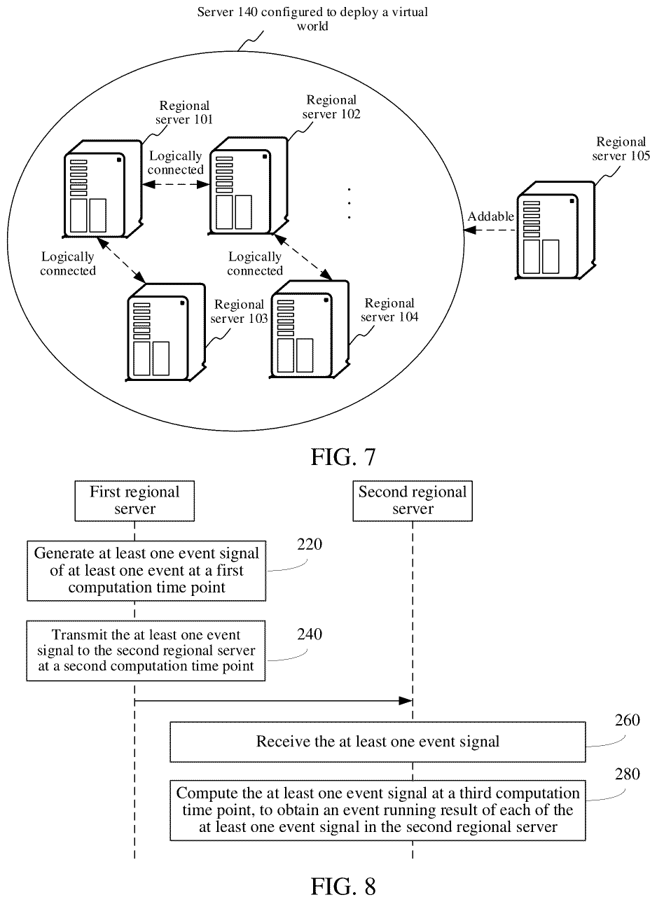

For example, FIG. 7 is a schematic diagram of an example server configured to deploy a virtual world according to one or more aspects described herein. In this arrangement, the server configured to deploy the virtual world may include at least two regional servers, and each regional server may be carried by one server or one server cluster in the physical world. Each regional server may maintain its own data and cycle. For example, refer to FIG. 7. The server 140 configured to deploy the virtual world may include a regional server 101, a regional server 102, a regional server 103, and a regional server 104. The regional server 101 may be logically connected to the regional server 102 and the regional server 103, and the regional server 102 is logically connected to the regional server 101 and the regional server 104. The regional server 101 might only be able to transmit an event signal to the regional server 102 and/or the regional server 103 logically connected to the regional server 101, and might not be able to directly transmit an event signal to the regional server 104. In some arrangements, in a case that an event is generated in a regional server, before an event signal of the event is transferred to a current regional server, the event might not affect running of the current regional server. The event may participate in the running of the current regional server until the event signal of the event is transferred to the current regional server. For example, refer to FIG. 7. The current regional server may be the regional server 102. When an event is generated in the regional server 101, before an event signal of the event is transferred to the regional server 102, the event might not affect running of the regional server 102. The event may participate in the running of the regional server 102 until the event signal of the event is transferred to the regional server 102. In some arrangements, each regional server may generate an event signal corresponding to an event according to its own cycle, transmit the event signal to another logically connected regional server, and compute a received event signal. For example, refer to FIG. 7. In the regional server 101, the regional server 101 may generate an event signal corresponding to an event according to its own cycle, and transmits the event signal to the regional server 102. The regional server 102 may receive the event signal, and the regional server 102 may compute the event signal according to its own cycle, so that the event signal participates in running of the regional server 102.

In some arrangements, new regional servers may be continuously added to the server configured to deploy the virtual world. In other words, the virtual world in this arrangement may continuously expand. A new regional server might only be logically connected to an existing regional server that is adjacent to the new regional server, and might not be logically connected to an existing regional server that is not adjacent to the new regional server. In other words, an original logical connection of the existing regional server that is not adjacent to the new regional server is not changed. When a new regional server is added, the new regional server might not affect running of an existing regional server. When an event is generated in the new regional server, and an event signal of the event is transferred to the existing regional server, the running of the existing regional server may be affected. For example, refer to FIG. 7. A new regional server may be added to the server 140 configured to deploy the virtual world. The new regional server may be a regional server 105. When the regional server 105 is added, the regional server 101, the regional server 102, the regional server 103, and the regional server 104 might not be affected. Assuming that the regional server 105 is logically connected to the regional server 101, an event may be generated in the regional server 105, and when an event signal of the event in the regional server 105 is transferred to the regional server 101, running of the regional server 101 may be affected.

Operations of an example virtual world-based information transfer method of this arrangement are briefly described by using an example in which the server configured to deploy the virtual world includes at least two regional servers, and the at least two regional servers include a first regional server and a second regional server that are logically connected.

Operation 1: The first regional server generates at least one event signal of at least one event at a first computation time point.

Operation 2: The first regional server transmits the at least one event signal to the second regional server at a second computation time point, the second computation time point being a next computation time point following the first computation time point determined based on a first cycle, and the first cycle being a computation cycle corresponding to the first regional server.

Operation 3: The second regional server receives the at least one event signal.

Operation 4: The second regional server computes the at least one event signal at a third computation time point, to obtain an event running result of each of the at least one event signal in the second regional server, the third computation time point being a computation time point determined based on a second cycle, and the second cycle being a computation cycle corresponding to the second regional server.

In conclusion, according to the virtual world-based information transfer method provided in this arrangement, the server configured to deploy the virtual world includes the at least two regional servers. Each regional server might only need to maintain data and a cycle of the regional server without need to care about data of another regional server and a need for synchronizing the data of the another regional server. For an event occurring in the another regional server, an event signal may be computed only when the event signal of the event can be transferred to the regional server and the event signal has already been transferred to the regional server, so that the event signal participates in running of the regional server. According to this, the method in arrangements described herein may be applied to a cloud technology scenario such as a cloud game, and can implement expansion of a quantity of regional servers of a game without being limited by computation capabilities of the regional servers, so that boundlessness and infinity of the game is implemented, to construct a boundless and infinite cloud game world and further provide a new game world view.

FIG. 8 is a flowchart of an example virtual world-based information transfer method according to one or more aspects described herein. A server configured to deploy a virtual world may include at least two regional servers, and the at least two regional servers may include a first regional server and a second regional server that are logically connected. For different regional servers, clocks of the different regional servers might not be synchronized. The following arrangement uses a system in which the first regional server and the second regional server are located as an example to describe an information transfer process between the first regional server and the second regional server. The method includes the following operation 220, operation 240, operation 260, and operation 280.

Operation 220: The first regional server generates at least one event signal of at least one event at a first computation time point.

The first regional server is one of the at least two regional servers of the server configured to deploy the virtual world.

The first regional server has a corresponding computation cycle, which may be referred to as a first cycle. A length of the first cycle may be a preconfigured time interval, or may be at least one frame interval. The preconfigured time interval may be related to a computation capability of the first regional server. A stronger computation capability may indicate a shorter preconfigured time interval. For example, if the first regional server is preconfigured to perform computation or has a computation capability to support computation every one second(s), the length of the first cycle may be 1 s. Alternatively, if a frame is rendered and displayed every 16 milliseconds (ms), the length of the first cycle may be 16 ms. The first computation time point may be a computation time point determined based on the first cycle. For example, if the length of the first cycle is 1 s, in other words, the first regional server performs computation at the 0^{th} second, the 1^{st} second, the 2^{nd} second, and the 3^{rd} second separately, the first computation time point may be one of the 0^{th} second, the 1^{st} second, the 2^{nd} second, and the 3^{rd} second. An event may be a basic unit running in a virtual world of an entire game in this arrangement, and the event may be configured for indicating that at least one type of attribute information, such as a location, a style, a virtual level, and a decoration, of at least one virtual element in the virtual world changes, or may be configured for indicating that there is a message in the virtual world that needs to be transferred or broadcast. One event corresponds to one event signal, and the event signal may be a signal including description information of the event.

In one arrangement, because an event signal corresponding to an event might need to be transferred between the first regional server and the second regional server, the event may relate to at least two regional servers. Specifically, the event may be a virtual activity performed by a virtual object controlled by a player, for example, a unidirectional transfer event in which the virtual object controlled by the player travels from a regional server to another regional server. The event may alternatively be a propagation event of the virtual activity, for example, an event of broadcasting that a virtual competition in a regional server generates a champion. The event may alternatively be another event unrelated to the virtual object controlled by the player, for example, an event of broadcasting that there is an available virtual item in a regional server. The foregoing descriptions do not exclude an event that relates to only one regional server, for example, a virtual object controlled by a player performs a virtual activity such as moving or picking up in one regional server.

In one arrangement, the description information of the event may include at least one of virtual mass, virtual energy, and an event description vector that are corresponding to the event. The event description vector may include at least one of an event attribute of the event, a regional server in which the event is located, a logical position of the event in the regional server, and a generation moment of the event in the regional server. The event attribute of the event and the logical position of the event in the regional server may participate in running of the second regional server. The event description vector may include the event attribute of the event, the regional server in which the event is located, the logical position of the event in the regional server, and the generation moment of the event in the regional server that may all be configured for uniquely representing the event. The event attribute may include at least one of an area, a shape, a form, a color, and a posture of the event in virtual world space.

In a regional server, at least one event may occur at a computation time point or in a cycle time period between the computation time point and a previous computation time point, and at least one event signal corresponding to the at least one event may be generated at the computation time point. The at least one event may include at least one of an event occurring at the computation time point and an event occurring within the cycle time period between the computation time point and the previous computation time point. A length of the cycle time period may be the same as a length of a cycle corresponding to the regional server.

For example, a length of a cycle corresponding to a regional server may be 1s. At the 1^{st} second in the regional server, a spreading event in which a player 1 wins a competition champion may occur, and at the same time, a unidirectional transfer event in which a player 2 travels from the first regional server to the second regional server may occur. In this case, two corresponding event signals may be respectively generated at the 1^{st} second. Alternatively, a spreading event in which a player 1 wins a competition champion occurs at the 0.5^{th} second, and a unidirectional transfer event in which a player 2 travels from the first regional server to the second regional server occurs at the 1^{st} second. In this case, two corresponding event signals may be respectively generated at the 1^{st} second. In other words, the first regional server generates the at least one event signal corresponding to the at least one event at the first computation time point.

Operation 240: The first regional server transmits the at least one event signal to the second regional server at a second computation time point, the second computation time point being a next computation time point following the first computation time point determined based on a first cycle, and the first cycle being a computation cycle corresponding to the first regional server.

The second regional server may be another regional server in the at least two regional servers of the server configured to deploy the virtual world. The second regional server and the first regional server may be different regional servers. The second computation time point may be the next computation time point following the first computation time point determined based on the first cycle. For example, the length of the first cycle is 1 s, in other words, the first regional server performs computation at the 0^{th} second, the 1^{st} second, the 2^{nd} second, and the 3^{rd} second separately. In a case that the first computation time point may be the 1^{st} second, the second computation time point may be the 2^{nd} second, and in a case that the first computation time point is the 2^{nd} second, the second computation time point may be the 3^{rd} second.

The first regional server may transmit the at least one event signal to the second regional server at the second computation time point. In one arrangement, a first transceiver may be disposed on the first regional server, and the first transceiver may be configured to transmit or receive at least one event signal. For example, the first regional server may generate at least one event signal at the first computation time point, deliver the at least one event signal to a queue of the first transceiver, and transmit, at the second computation time point, the at least one event signal to the second regional server by using the first transceiver.

Operation 260: The second regional server receives the at least one event signal.

The second regional server may receive the at least one event signal. In one arrangement, a second transceiver may be disposed on the second regional server, and the second transceiver may be configured to receive or transmit at least one event signal. For example, the second regional server may receive, by using the second transceiver, at least one event signal transmitted by the first regional server. The second transceiver of the second regional server in this arrangement may be in a continuous receiving state. For example, an upper limit of a quantity of event signals transmitted or received by the first transceiver and the second transceiver per unit time may be related to computation capabilities of regional servers in which the transceivers are located. In an example, when the second regional server reaches an upper limit of a computation capability or a preset capability threshold when receiving an event signal, a quantity of event signals received per unit time may be limited, so that an unreceived event signal may be deferred to a next moment for receiving. Similarly, when the first regional server transmits an event signal, a similar limitation may be set to avoid a corresponding regional server reaching an upper limit of a computation capability during transmitting or receiving an event signal.

Operation 280: The second regional server computes the at least one event signal at a third computation time point, to obtain an event running result of each of the at least one event signal in the second regional server, the third computation time point being a computation time point determined based on a second cycle, and the second cycle being a computation cycle corresponding to the second regional server.

The second regional server may correspond to the second cycle, and the second cycle may be the computation cycle corresponding to the second regional server. A length of the second cycle may be a preconfigured time interval, or may be at least one frame interval. The preconfigured time interval may be related to a computation capability of the second regional server. A stronger computation capability may indicate a shorter preconfigured time interval. In one arrangement, the second cycle may be different from the first cycle. Different regional servers in this arrangement may maintain different cycles and virtual time zones. For example, if the second regional server is preconfigured to perform computation every two seconds(s), the length of the second cycle may be 2 s. Alternatively, if a frame is rendered and displayed every 32 milliseconds (ms), the length of the second cycle may be 32 ms.

The third computation time point may be a computation time point determined based on the second cycle. For example, if the length of the second cycle is 2 s, in other words, the second regional server performs computation at the 0^{th} second, the 2^{nd} second, the 4^{th} second, and the 6^{th} second separately, the third computation time point may be one of the 0^{th} second, the 2^{nd} second, the 4^{th} second, and the 6^{th} second. Because in this arrangement, different regional servers may maintain their own virtual time zones respectively, the third computation time point might not be able to be compared with the first computation time point and the second computation time point in a time sequence. In other words, there may be no limitation to the time sequence of the third computation time point, the first computation time point, and the second computation time point. For example, the first regional server may be in a 24-hour system, and the second regional server may be in a 48-hour system. Therefore, when the first regional server transmits, at its own 9:00 a.m. (the second computation time point), an event signal to the second regional server, the second regional server may compute the received event signal at its own 8:00 a.m. (the third computation time point), so that it may be impossible to determine that the third computation time point is earlier than the second computation time point.

In one arrangement, the second regional server may compute the at least one event signal at the third computation time point, to obtain the event running result of each of the at least one event signal in the second regional server. The event running result may be determined based on an event type of the at least one event corresponding to the at least one event signal. For example, if the event is a spreading event, the event running result may be broadcasting the event. If the event is a unidirectional transfer event, the event running result may be computing a trajectory of the unidirectional transfer event, an intersection of the unidirectional transfer event and a map boundary of the second regional server, and the like.

In conclusion, in the virtual world-based information transfer methods described herein, the server configured to deploy the virtual world may include the at least two regional servers, and the at least two regional servers may include the first regional server and the second regional server that are logically connected. The first regional server may generate the at least one event signal of the at least one event at the first computation time point; and the first regional server may transmit the at least one event signal to the second regional server at the second computation time point. The second computation time point may be the next computation time point following the first computation time point determined based on the first cycle, and the first cycle may be the computation cycle corresponding to the first regional server. The second regional server may receive the at least one event signal; and the second regional server may compute the at least one event signal at the third computation time point, to obtain the event running result of each of the at least one event signal in the second regional server. The third computation time point may be the computation time point determined based on the second cycle, and the second cycle may be the computation cycle corresponding to the second regional server. According to the method in this arrangement, for a regional server, the regional server might only need to maintain data and a cycle of the regional server without a need of caring about data of another regional server and without a need of synchronizing the data of the another regional server. For an event occurring in the another regional server, an event signal may be computed only when the event signal of the event can be transferred to the regional server and the event signal has already been transferred to the regional server, so that the event signal may participate in running of the regional server. According to this, the methods described herein may be applied to a cloud technology scenario such as a cloud game, and can implement expansion of a quantity of regional servers of a game without being limited by computation capabilities of the regional servers, so that boundlessness and infinity of the game is implemented, to construct a boundless and infinite cloud game world and further provide a new game world view.

In some arrangements, assuming that a next computation time point following a computation time point 1 of a regional server is a computation time point 2, in a case that an event signal transmitted by another regional server is received between the computation time point 1 and the computation time point 2, because the regional server is already in a computation state at the computation time point 1, the regional server computes the received event signal at the computation time point 2.

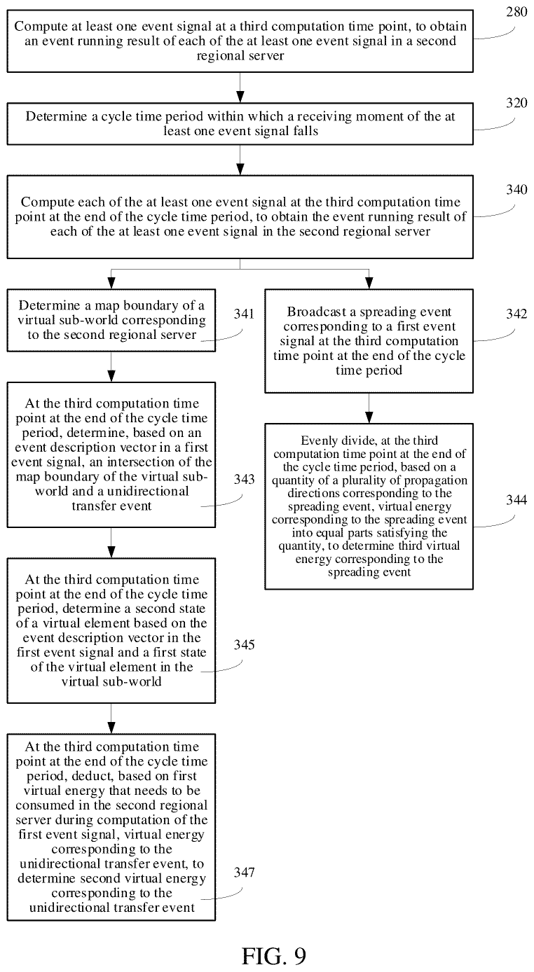

For example, FIG. 9 is a schematic diagram of an example virtual world-based information transfer method according to one or more aspects described herein. In one arrangement, operation 280 may include the following operation 320 and operation 340.

Operation 320: The second regional server determines a cycle time period within which a receiving moment of the at least one event signal falls, the receiving moment being a moment within the cycle time period, and a length of the cycle time period being equal to the second cycle.

The cycle time period may be a time period determined based on the second cycle, and the length of the cycle time period is equal to the second cycle. The receiving moment may be a moment at which the second regional server receives the at least one event signal, and the receiving moment may be the moment within the cycle time period. For example, the second regional server may determine the cycle time period within which the receiving moment of the at least one event signal falls. For example, if the second regional server performs computation every 10 s, that is, the second cycle is 10 s, the length of the cycle time period may be 10 s. Assuming that the second regional server determines that the receiving moment of the at least one event signal is the 5^{th} second, the second regional server may determine that a cycle time period within which the 5^{th} second falls is a cycle time period corresponding to the 1^{st} second to the 10^{th} second, and the 1^{st} second and the 10^{th} second may both be computation time points of the second regional server.

Operation 340: The second regional server computes each of the at least one event signal at the third computation time point at the end of the cycle time period, to obtain the event running result of each of the at least one event signal in the second regional server.

The third computation time point may be a computation time point at the end of the cycle time period. In one arrangement, the second regional server may compute each of the at least one event signal at the third computation time point at the end of the cycle time period, to obtain the event running result of each of the at least one event signal in the second regional server.

For example, if the second regional server may perform computation every 10 s, that is, the second cycle is 10 s, the length of the cycle time period may be 10 s. Assuming that the second regional server determines that the receiving moment of the at least one event signal is the 5^{th} second, the second regional server may determine that a cycle time period within which the 5^{th} second falls is a cycle time period corresponding to the 1^{st} second to the 10^{th} second, and the 1^{st} second and the 10^{th} second may both be computation time points of the second regional server. The third computation time point at the end of the cycle time period is the 10^{th} second. The second regional server computes the at least one event signal at the 10^{th} second, and may obtain the event running result of each of the at least one event signal in the second regional server.

In this arrangement, the second regional server may compute the at least one event signal at the third computation time point after receiving the at least one event signal. It may be ensured that the at least one event signal can affect running of the second regional server, while avoiding the event signal immediately affecting the second regional server to cause the second regional server to reach an upper limit of the computation capability. The event signal may be received and computed at different moments. Regardless of how many events are generated in the first regional server, the second regional server might only need to process event signals of a limited quantity of events in one computation, to avoid reaching the upper limit of the computation capability of the second regional server.

In some arrangements, the at least two regional servers may each correspond to a virtual sub-world in the virtual world, the at least one event may include a first event, and the at least one event signal may include a first event signal.

In one arrangement, the first event may be a unidirectional transfer event. Next, three aspects are described: a position at which the unidirectional transfer event is transferred to the second regional server, an overall state of a virtual element participating in the unidirectional transfer event when the unidirectional transfer event is transferred to the second regional server, and virtual energy carried in the unidirectional transfer event when the unidirectional transfer event is transferred to the second regional server. Still referring to FIG. 9, operation 340 may include the following operation 341 and operation 343, and/or operation 340 may include the following operation 345, and/or operation 340 may include the following operation 347.

Operation 341: The second regional server determines a map boundary of a virtual sub-world corresponding to the second regional server.

In this arrangement, for a regional server, a clock may be synchronized inside the regional server. Therefore, each regional server may correspond to a virtual sub-world in the virtual world, and the virtual sub-world may have a sub-world map. Virtual sub-worlds of different regional servers may be independent of each other, and a sub-world map of each regional server may have a corresponding boundary, which is referred to as a map boundary. For example, the second regional server may determine the map boundary of the virtual sub-world corresponding to the second regional server.

The second regional server may perform at least one of the following operations on the first event signal at the third computation time point at the end of the cycle time period:
Operation 343: The second regional server determines an intersection of the map boundary of the virtual sub-world and the unidirectional transfer event based on an event description vector in the first event signal.

The first event signal may include an event description vector of the first event. The event description vector may include at least one of an event attribute of the event, a regional server in which the event is located, a logical position of the event in the regional server, and a generation moment of the event in the regional server. For example, at the third computation time point at the end of the cycle time period, the second regional server may determine the intersection of the map boundary of the virtual sub-world and the unidirectional transfer event based on the event description vector in the first event signal.

In one arrangement, the event description vector in the first event signal may include an event attribute of the first event and a logical position corresponding to the first event. The logical position corresponding to the first event may be a position of a horizontal coordinate, a vertical coordinate, and a depth coordinate of the first event in an inertial reference frame corresponding to the first regional server. For example, the second regional server may determine the intersection of the map boundary of the virtual sub-world and the unidirectional transfer event based on the event attribute and the logical position in the event description vector.

For example, the unidirectional transfer event may be that a virtual item flies into the virtual sub-world corresponding to the second regional server. The second regional server may determine the intersection of the map boundary of the virtual sub-world and the unidirectional transfer event based on the event attribute and the logical position in the event description vector. Then, for a client supporting a virtual world in a terminal, the flying virtual item may be displayed at a position of the intersection.

Operation 345: The second regional server determines a second state of a virtual element based on the event description vector in the first event signal and a first state of the virtual element in the virtual sub-world.

The first state may be an initial state of the virtual element before the second regional server computes the first event signal, and the second state may be a changed state of the virtual element after the second regional server computes the first event signal. For example, the second regional server may determine the second state of the virtual element based on the event description vector in the first event signal and the first state of the virtual element in the virtual sub-world. In one arrangement, the event description vector in the first event signal may include an event attribute of the first event and a logical position corresponding to the first event. The logical position corresponding to the first event may be a position of a horizontal coordinate, a vertical coordinate, and a depth coordinate of the first event in an inertial reference frame corresponding to the first regional server. For example, the second regional server may determine the second state of the virtual element based on the event attribute and the logical position in the event description vector and the first state of the virtual element in the virtual sub-world.

For example, the unidirectional transfer event may be that a virtual item flies into the virtual sub-world corresponding to the second regional server. The first state of the virtual element may be a static state, and the second state of the virtual element may be a state of being moved blown by wind during flying of the virtual item. Then, for a client supporting a virtual world in a terminal, a visual effect that the virtual element is blown by the wind during the flying of the virtual item may be displayed by respectively rendering image frames in the static state and the state of being moved.

Operation 347: The second regional server deducts, based on first virtual energy that needs to be consumed in the second regional server during computation of the first event signal, virtual energy corresponding to the unidirectional transfer event, to determine second virtual energy corresponding to the unidirectional transfer event.

For example, the virtual energy may be configured for supporting a process of transferring an event between different regional servers. When a virtual element corresponding to the event moves in the virtual world, or a message corresponding to the event is transferred or broadcast in the virtual world, the virtual energy may be consumed and deduction occurs.

When the event is configured for indicating a location change of the virtual element, the virtual energy may overcome virtual gravity of the virtual element, resistance when the virtual element moves, or the like to provide power for the location change of the virtual element. In a case that the event is configured for indicating that there is a message in the virtual world that needs to be transferred or broadcast, the virtual energy may support the message in being transferred or broadcast, and the virtual energy may decrease as a distance for transferring or broadcasting the message increases.

An energy value of the virtual energy corresponding to the event may vary based on at least one of a type of the event, an event attribute, a generation moment, and a regional server in which the event is located.

In an example in which the virtual element corresponding to the event moves in the virtual world, the type of the event may include at least a unidirectional transfer event or a spreading event. In the unidirectional transfer event, the virtual element may move in one direction in the virtual world (for example, a virtual object controlled by a player moves from the first regional server to the second regional server). In the spreading event, the virtual element may move in at least two directions in the virtual world (for example, lightning light and shadowing in the first regional server spread to adjacent regional servers). In comparison with the spreading event, the unidirectional transfer event may have fewer movement directions of the virtual element, and accordingly, the virtual energy supporting a transfer process may also be lower. The event attribute may be configured for indicating a type of the moving virtual element. In a case that movement is maintained at the same moving speed/distance, the virtual energy may increase as virtual mass of the virtual element increases.

The regional server in which the event is located has a corresponding virtual landform. An elevation of the virtual landform may affect gravitational potential energy of the virtual element. The gravitational potential energy may be a part of the virtual energy of the virtual element, and may increase as the elevation of the virtual landform increases.

Different generation moments of the event may correspond to different virtual weathers, and there may be a corresponding movement speed in the virtual weather. Using a virtual sunny day and a virtual rainy day as examples, in the virtual sunny day, a movement speed of the virtual element may be greater than that in the virtual rainy day. Accordingly, to support movement of the virtual element to reach the movement speed, virtual energy of the virtual element in the virtual sunny day may be higher than virtual energy in the virtual rainy day.

The first virtual energy may be virtual energy that needs to be consumed during computation of the unidirectional transfer event in the second regional server. The second virtual energy may be remaining virtual energy after the second regional server computes the unidirectional transfer event, in other words, after the unidirectional transfer event affects the running of the second regional server.

In an example, the unidirectional transfer event may be a virtual meteorite movement event. After a virtual meteorite stops moving, a player who is in a regional server in which the virtual meteorite is located may obtain a virtual material carried on or dropped from the virtual meteorite. A regional server in which the virtual meteorite is initially observed may be the first regional server. In the first regional server, the virtual meteorite may move toward a preset direction until the virtual meteorite reaches a map boundary corresponding to the first regional server, to leave a virtual sub-world corresponding to the first regional server and enter the virtual sub-world corresponding to the second regional server. In the second regional server, energy consumed by the virtual meteorite may be in a positive correlation with a movement distance of the virtual meteorite in the virtual sub-world corresponding to the second regional server. The second regional server may deduct the virtual energy corresponding to the unidirectional transfer event (the virtual meteorite movement event), to determine the second virtual energy corresponding to each moment of movement of the unidirectional transfer event (the virtual meteorite movement event) in the virtual sub-world corresponding to the second regional server.

In one arrangement, the virtual energy corresponding to the event may be continuously attenuated in an event transfer process. For example, the second regional server may deduct, based on the first virtual energy that needs to be consumed in the second regional server during computation of the first event signal, the virtual energy corresponding to the unidirectional transfer event, to determine the second virtual energy corresponding to the unidirectional transfer event.

For example, when the unidirectional transfer event is transferred to the second regional server, the virtual energy corresponding to the unidirectional transfer event may be 10, and the first virtual energy that needs to be consumed in the second regional server during computation may be 3, and then the deducted second virtual energy corresponding to the unidirectional transfer event may be determined to be 7. In one arrangement, in a case that the second virtual energy corresponding to the unidirectional transfer event is greater than or equal to an energy threshold, the second regional server may continue to transfer the unidirectional transfer event to a third regional server.

For example, the deducted second virtual energy corresponding to the unidirectional transfer event may be 7. If an energy threshold for the unidirectional transfer event to continue to be transferred is 1, the second regional server can continue to transfer the unidirectional transfer event to the third regional server.

In some arrangements, the at least two regional servers may each correspond to a virtual sub-world in the virtual world, the at least one event may include a first event, and the at least one event signal may include a first event signal.

In one arrangement, the first event may be a spreading event. Still referring to FIG. 9, operation 340 may be implemented as the following operation 342, and/or, operation 340 may be implemented as the following operation 344.

Operation 342: The second regional server broadcasts the spreading event corresponding to the first event signal at the third computation time point at the end of the cycle time period.

In one arrangement, the second regional server may broadcast, in at least one broadcasting manner, the spreading event corresponding to the first event signal at the third computation time point at the end of the cycle time period. The at least one broadcasting manner may include at least one of audio broadcasting, text broadcasting, video broadcasting, and pop-up window broadcasting. For example, the spreading event may refer to a player 1 winning a competition champion in the first regional server. The second regional server may broadcast the spreading event at the third computation time point at the end of the cycle time period after receiving the first event signal corresponding to the spreading event.

Operation 344: The second regional server evenly divides, at the third computation time point at the end of the cycle time period, based on a quantity of at least two propagation directions corresponding to the spreading event, virtual energy corresponding to the spreading event into equal parts satisfying the quantity, to determine third virtual energy corresponding to the spreading event.

The spreading event may correspond to the at least two propagation directions, and can be propagated to a regional server other than the first regional server that is logically connected to the second regional server. The third virtual energy may be virtual energy corresponding to the spreading event when the second regional server continues to transfer the event signal of the spreading event after computing the spreading event.

For example, the second regional server may evenly divide, at the third computation time point at the end of the cycle time period, based on the quantity of the at least two propagation directions corresponding to the spreading event, the virtual energy corresponding to the spreading event into the equal parts satisfying the quantity, to determine the third virtual energy corresponding to the spreading event.

For example, when the spreading event is transferred to the second regional server, the virtual energy corresponding to the spreading event may be 10. After the spreading event is broadcast in the second regional server, the spreading event may further correspond to two propagation directions, in other words, the spreading event may further need to be transferred to two regional servers, and it may be determined that the third virtual energy corresponding to the spreading event is 5.

In one arrangement, when the third virtual energy corresponding to the spreading event is greater than or equal to an energy threshold, the second regional server may continue to transfer the spreading event to a third regional server. For example, the third virtual energy corresponding to the spreading event may be 5. If an energy threshold for the spreading event to continue to be transferred is 1, the second regional server can continue to transfer the spreading event to the third regional server.

In the foregoing arrangement, the second regional server may perform, based on events of different types, processing manners corresponding to the types, to improve flexibility and pertinence of event processing, and further improve a data processing speed to some extent.

For example, the virtual mass may be a weight of the virtual element when at least one piece of attribute information of the virtual element in the virtual world changes. In one arrangement, a value of the virtual mass may remain unchanged, or may change during transfer in different regional servers.

In an example, the unidirectional transfer event may be a traveling event of a player in different regional servers. Description information of the unidirectional transfer event includes virtual mass and virtual energy corresponding to the event. The virtual mass may be configured for describing a weight of a virtual object controlled by the player. For example, the virtual mass may be used as attribute information of the virtual object, and is configured for constructing or displaying the virtual object in a new regional server after traveling. A value of the virtual mass may remain unchanged in a unidirectional transfer event process. In one arrangement, the virtual world may be a virtual universe. The first regional server before the unidirectional transfer event may be executed and the second regional server after the unidirectional transfer event is executed correspond to different virtual planets in the virtual universe. Affected by different gravity of the different virtual planets, the virtual mass of the virtual element may change. In another example, the unidirectional transfer event may be a traveling event that a virtual object controlled by a player drives a virtual vehicle in different regional servers. The virtual mass may be configured for describing a total weight of the virtual object controlled by the player and the virtual vehicle. In an example, the virtual object may drive a virtual spaceship to sail in a virtual universe, and a virtual sub-world corresponding to a regional server is at least one virtual planet and/or a part of space around a virtual planet in the virtual universe. Because the virtual universe provides vast virtual space, the virtual mass (the total weight of the virtual object and the virtual vehicle) may be associated with driving performance (a maximum speed, maximum acceleration, and the like) of the virtual vehicle, and the virtual mass is configured for determining the driving performance of the virtual vehicle in the unidirectional transfer event. For example, the virtual mass may decrease with movement by driving the virtual vehicle, to simulate fuel consumption of a vehicle in the real world. In one arrangement, the first regional server and the second regional server are far away from each other in the virtual world. To simplify movement by driving the virtual vehicle from a first location in the first regional server to a second location in the second regional server, an event running result of a traveling event of driving the virtual vehicle in the second regional server may be obtained by using the virtual world-based information transfer method described above. To avoid performing dull driving operations for a long time, when the event running result is obtained, the virtual mass may be deducted, to simulate fuel consumption of a vehicle in the real world.

In some arrangements, based on the foregoing arrangement, the at least one event signal may further be continuously transferred from the second regional server to the third regional server.

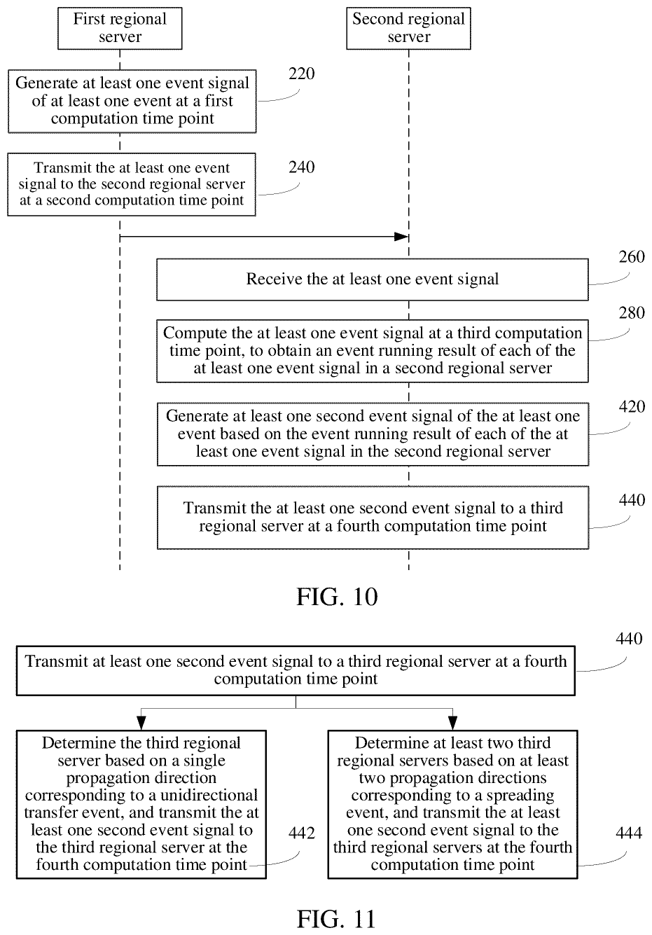

FIG. 10 is a flowchart of an example virtual world-based information transfer method according to one or more aspects described herein. The at least two regional servers further includes a third regional server logically connected to the second regional server, and the third regional server and the first regional server are different regional servers. The second regional server may transmit at least one event signal to the third regional server.

For example, based on operation 220, operation 240, operation 260, and operation 280, the method may further include operation 420 and operation 440.

Operation 420: The second regional server generates at least one second event signal of the at least one event based on the event running result of each of the at least one event signal in the second regional server.

The second event signal may be an event signal generated by the second regional server based on the event running result of each of the at least one event signal in the second regional server. In one arrangement, the second regional server may generate the at least one second event signal of the at least one event at the third computation time point based on the event running result of each of the at least one event signal in the second regional server.

Operation 440: The second regional server transmits the at least one second event signal to the third regional server at a fourth computation time point, the fourth computation time point being a computation time point determined based on the second cycle.

The fourth computation time point may be the computation time point determined based on the second cycle, and the fourth computation time point may be a next computation time point following the third computation time point determined based on the second cycle. In one arrangement, the second regional server may transmit the at least one second event signal to the third regional server at the fourth computation time point, the fourth computation time point being the computation time point determined based on the second cycle.

For example, a second transceiver may be disposed on the second regional server. The second regional server may generate at least one second event signal at the third computation time point, deliver the at least one second event signal to a queue of the second transceiver, and transmit, at the fourth computation time point, the at least one second event signal to the third regional server by using the second transceiver.

In this arrangement, the second regional server may further continue to transfer information to the third regional server logically connected to the second regional server, and may further enable an event to continue to produce an impact in the virtual world, thereby providing more possibilities for playability of the virtual world in this arrangement.

FIG. 11 is a flowchart of an example virtual world-based information transfer method according to one or more aspects described herein. The at least one event includes a second event, and the second event may be a unidirectional transfer event. Operation 440 may be implemented as the following operation 442.

Operation 442: The second regional server determines the third regional server based on a single propagation direction corresponding to the unidirectional transfer event, and transmits the at least one second event signal to the third regional server at the fourth computation time point.

If the unidirectional transfer event corresponds to the single propagation direction, the second regional server might need to transmit the at least one second event signal to the third regional server. For example, the second regional server may determine the third regional server based on the single propagation direction corresponding to the unidirectional transfer event, and transmit the at least one second event signal to the third regional server at the fourth computation time point.

Still refer to FIG. 11. The at least one event may include a second event, and the second event may be a spreading event. Operation 440 may be implemented as the following operation 444.

Operation 444: The second regional server determines at least two third regional servers based on at least two propagation directions corresponding to the spreading event, and transmits the at least one second event signal to the third regional servers at the fourth computation time point.

If the spreading event corresponds to the at least two propagation directions, the second regional server might need to transmit the at least one second event signal to the at least two third regional servers. In an example, the third regional server and the second regional server may be logically connected, and there may be an intersection, an intersection line, or an intersection surface of a map boundary of a virtual sub-world corresponding to the third regional server and the map boundary of the virtual sub-world corresponding to the second regional server. Based on adjacent transfer of the spreading event in virtual sub-worlds, a transfer rule of media such as a sound wave, a light wave, and an electromagnetic wave in a real event may be simulated.

For example, the second regional server may determine the at least two third regional servers based on the at least two propagation directions corresponding to the spreading event, and transmit the at least one second event signal to the third regional servers at the fourth computation time point.

In the foregoing arrangement, the second regional server may determine the third regional server based on a type of the event, so that the event signal of the event can be continuously transferred in different regional servers, and the regional servers can further be connected to each other. This may also represent completeness and continuity of the virtual world in this arrangement.

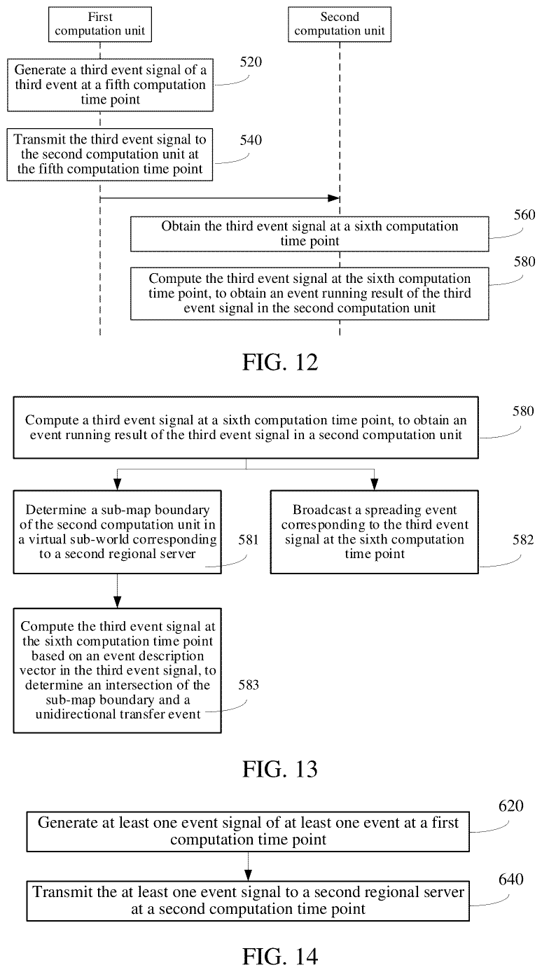

FIG. 12 is a flowchart of an example virtual world-based information transfer method according to one or more aspects described herein. The second regional server includes at least two computation units divided based on the virtual sub-world corresponding to the second regional server, the at least two computation units include a first computation unit and a second computation unit that are logically connected, and the first computation unit and the second computation unit are configured to compute the same event signal.

The at least two computation units in the second regional server may be divided based on at least one of the following:
1. a type of data that needs to be processed in the virtual sub-world corresponding to the second regional server, where for example, one type of data that needs to be processed in the virtual sub-world corresponding to the second regional server corresponds to one computation unit, for example, an event attribute and a logical position corresponding to an event are two types of data that need to be processed, and respectively correspond to computation units;
2. space of the virtual sub-world corresponding to the second regional server, where for example, the space of the virtual sub-world of the second regional server is divided into a plurality of computation units having a uniform polygon shape, for example, the virtual sub-world of the second regional server is divided into honeycomb shapes in space, and each piece of divided hexagonal space corresponds to a computation unit; and
3. a type of a virtual element included in the virtual sub-world corresponding to the second regional server, where for example, one type of a virtual element in the virtual sub-world corresponding to the second regional server corresponds to one computation unit, for example, virtual elements are a virtual plant and a virtual building, and each corresponds to one computation unit.

For a regional server, a clock is synchronized inside the regional server. The following arrangement uses the second regional server as an example to describe an information transfer process between the first computation unit and the second computation unit inside the second regional server. For the second regional server, the method further includes operation 520, operation 540, operation 560, and operation 580.

Operation 520: The first computation unit generates a third event signal of a third event at a fifth computation time point.

The first computation unit may be one of the at least two computation units in the second regional server.

The third event may be an event occurring in the first computation unit, and the third event signal may be an event signal generated by the first computation unit at the fifth computation time point and corresponding to the third event.

The fifth computation time point may be a computation time point determined based on the second cycle. For example, if the length of the second cycle is 2 s, in other words, the second regional server performs computation at the 0^{th} second, the 2^{nd} second, the 4^{th} second, the 6^{th} second separately, and the fifth computation time point may be one of the 0^{th} second, the 2^{nd} second, the 4^{th} second, and the 6^{th} second. For example, the first computation unit may generate the third event signal of the third event at the fifth computation time point.

Operation 540: The first computation unit transmits the third event signal to the second computation unit at the fifth computation time point.

The second computation unit may be another computation unit of the at least two computation units in the second regional server. The first computation unit and the second computation unit may be different computation units.

For example, because the first computation unit and the second computation unit belong to the same second regional server, the second regional server may transmit the event signal in a manner of clock synchronization. In other words, the first computation unit may transmit the third event signal to the second computation unit at the fifth computation time point.

Operation 560: The second computation unit obtains the third event signal at a sixth computation time point.

The sixth computation time point may be a computation time point determined based on the second cycle, and the sixth computation time point may be a next computation time point following the fifth computation time point determined based on the second cycle. For example, if the length of the second cycle is 2 s, and the fifth computation time point is the 4^{th} second, the sixth computation time point may be the 6^{th} second.

For example, the second computation unit may obtain the third event signal at the sixth computation time point.

Operation 580: The second computation unit computes the third event signal at the sixth computation time point, to obtain an event running result of the third event signal in the second computation unit.

The fifth computation time point may be the computation time point determined based on the second cycle, and the sixth computation time point may be the next computation time point following the fifth computation time point determined based on the second cycle.

For example, the second computation unit may compute the third event signal at the sixth computation time point, to obtain the event running result of the third event signal in the second computation unit, so that the third event signal participates in running of the second computation unit.

In some arrangements, the first computation unit and the second computation unit may transmit and obtain event signals through a shared storage region. Specifically, the second regional server may be provided with a shared storage region. The shared storage region may be a storage region shared by the at least two computation units, and each of the at least two computation units may correspond to a sub-region in the shared storage region.

In one arrangement, in the same second regional server, one computation unit might only be able to transmit an event signal to another computation unit that is logically adjacent to the computation unit, and the computation unit might only be able to access a sub-region of the another computation unit that is logically adjacent to the computation unit in the shared storage region.

For example, the first computation unit may write the third event signal into a sub-region corresponding to the second computation unit in the shared storage region at the fifth computation time point, so that the second computation unit reads, at the sixth computation time point, the third event signal from the sub-region corresponding to the second computation unit in the shared storage region.

In this arrangement, for different computation units in the same second regional server, information transfer can also be implemented between the different computation units, so that the information transfer is more efficient, and interaction between the different computation units is implemented. In addition, an event signal from the first computation unit may start to affect running of the second computation unit at a next computation time point, to ensure current running stability.

In some arrangements, similar to information transfer between regional servers, inside the same second regional server, there may be information transfer manners corresponding to different types of events.

FIG. 13 is a flowchart of an example virtual world-based information transfer method according to an one or more aspects described herein. For example, the third event may include a unidirectional transfer event, and then operation 580 may be implemented as the following operation 581 and operation 583.

Operation 581: The second computation unit determines a sub-map boundary of the second computation unit in the virtual sub-world corresponding to the second regional server.

Each computation unit in the second regional server may correspond to a world map in the virtual sub-world of the second regional server. A boundary of the world map corresponding to the computation unit in the virtual sub-world may be referred to as a sub-map boundary.

For example, the second computation unit may determine the sub-map boundary of the second computation unit in the virtual sub-world corresponding to the second regional server.

Operation 583: The second computation unit computes the third event signal at the sixth computation time point based on an event description vector in the third event signal, to determine an intersection of the sub-map boundary and the unidirectional transfer event.

The third event signal may include the event description vector of the third event signal. The event description vector may include at least one of an event attribute of the event, a regional server in which the event is located, a logical position of the event in the regional server, and a generation moment of the event in the regional server. For example, the second computation unit may compute the third event signal at the sixth computation time point based on the event description vector in the third event signal, to determine the intersection of the sub-map boundary and the unidirectional transfer event. In one arrangement, the second computation unit may compute the third event signal at the sixth computation time point based on the event attribute and the logical position in the event description vector of the third event signal, to determine the intersection of the sub-map boundary and the unidirectional transfer event.

For example, if the unidirectional transfer event is that a virtual item in the second regional server flies from space of the first computation unit in the virtual sub-world to space of the second computation unit in the virtual sub-world, the second computation unit determines the intersection between the sub-map boundary of the second computation unit and the unidirectional transfer event based on the event attribute and the logical position in the event description vector. Then for a client supporting a virtual world in a terminal, the flying virtual item may be displayed at a position of the intersection.

In some arrangements, similar to information transfer between regional servers, the second computation unit may perform at least one of the following processing operations on the third event signal at the sixth computation time point. In one arrangement, the second computation unit may determine a fourth state of a virtual element based on the event description vector in the third event signal and a third state of the virtual element on the sub-map boundary. The third state may be an initial state of the virtual element, and the fourth state may be a changed state of the virtual element.

In one arrangement, the second computation unit may deduct, based on fourth virtual energy that needs to be consumed in the second computation unit during computation of the third event signal, virtual energy corresponding to the unidirectional transfer event, to determine fifth virtual energy corresponding to the unidirectional transfer event.

In one arrangement, when the fifth virtual energy corresponding to the unidirectional transfer event may be greater than or equal to an energy threshold, the second computation unit may continue to transfer the unidirectional transfer event to a third computation unit.

Still referring to FIG. 13, in one example, the third event may include a spreading event. Operation 580 may include the following operation 582.

Operation 582: The second computation unit broadcasts the spreading event corresponding to the third event signal at the sixth computation time point.

In one arrangement, the second computation unit may broadcast, in at least one broadcasting manner, the spreading event corresponding to the third event signal at the sixth computation time point. The at least one broadcasting manner may include at least one of audio broadcasting, text broadcasting, video broadcasting, and pop-up window broadcasting.

For example, the spreading event may refer to a player 1 wining a competition champion in the first computation unit. The second computation unit may broadcast the spreading event at the sixth computation time point after receiving the third event signal corresponding to the spreading event.

In one arrangement, the second computation unit may evenly divide, at the sixth computation time point, based on a quantity of at least two propagation directions corresponding to the spreading event, the virtual energy corresponding to the spreading event into equal parts satisfying the quantity, to determine sixth virtual energy corresponding to the spreading event.

In one arrangement, when the sixth virtual energy corresponding to the spreading event is greater than or equal to an energy threshold, the second computation unit may continue to transfer the spreading event to a third computation unit.

In the foregoing arrangement, the second computation unit may perform, based on events of different types, processing manners corresponding to the types, to improve flexibility and pertinence of event processing, and further improve a data processing speed to some extent.

FIG. 14 is a flowchart of a virtual world-based information transfer method according to one or more aspects described herein. A server configured to deploy a virtual world includes at least two regional servers, and the at least two regional servers include a first regional server and a second regional server that are logically connected.

The following arrangement uses an example in which the method is performed by the first regional server, to describe an information transfer process corresponding to the first regional server. The method includes the following operation 620 and operation 640.

Operation 620: Generate at least one event signal of at least one event at a first computation time point.

Operation 640: Transmit the at least one event signal to the second regional server at a second computation time point, the first computation time point and the second computation time point being adjacent computation time points determined based on a first cycle, and the first cycle being a computation cycle corresponding to the first regional server; and the at least one event signal being configured for being computed by the second regional server at a third computation time point after the at least one event signal is received by the second regional server, to obtain an event running result of each of the at least one event signal in the second regional server, the third computation time point being a computation time point determined based on a second cycle, and the second cycle being a computation cycle corresponding to the second regional server.

For descriptions of the virtual world-based information transfer method performed by the first regional server in this arrangement, refer to descriptions corresponding to the first regional server in the foregoing arrangement descriptions. Details are not described here again.

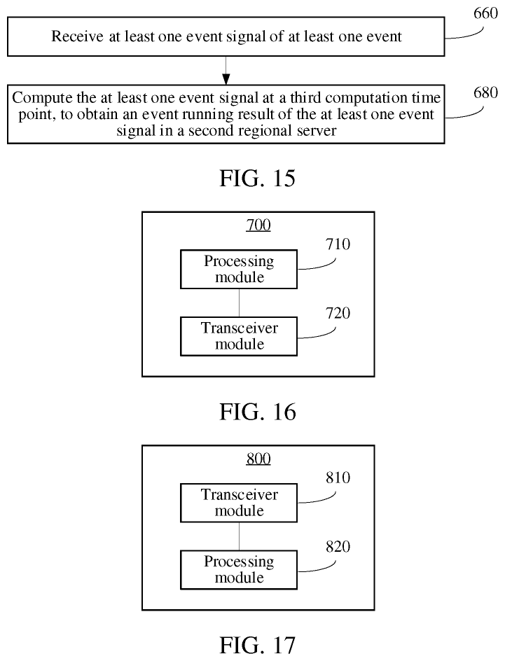

FIG. 15 is a flowchart of an example virtual world-based information transfer method according to one or more aspects described herein. A server configured to deploy a virtual world may include at least two regional servers, and the at least two regional servers may include a first regional server and a second regional server that are logically connected.

The following arrangement uses an example in which the method is performed by the second regional server, to describe an information transfer process corresponding to the second regional server. The method may include the following operation 660 and operation 680.

Operation 660: Receive at least one event signal of at least one event.

Operation 680: Compute the at least one event signal at a third computation time point, to obtain an event running result of the at least one event signal in the second regional server, the third computation time point being a computation time point determined based on a second cycle, and the second cycle being a computation cycle corresponding to the second regional server;
the at least one event signal being generated by the first regional server at a first computation time point and transmitted to the second regional server at a second computation time point; and the first computation time point and the second computation time point being adjacent computation time points determined based on a first cycle, and the first cycle being a computation cycle corresponding to the first regional server.

In some arrangements, operation 680 may be implemented as: determining a cycle time period within which a receiving moment of the at least one event signal falls, the receiving moment being a moment within the cycle time period, and a length of the cycle time period being equal to the second cycle; and computing each of the at least one event signal at the third computation time point at the end of the cycle time period, to obtain the event running result of each of the at least one event signal in the second regional server.

In some arrangements, the at least two regional servers each may correspond to a virtual sub-world in the virtual world, the at least one event may include a first event, the at least one event signal may include a first event signal, and the first event may be a unidirectional transfer event.

The computing each of the at least one event signal may include: determining a map boundary of a virtual sub-world corresponding to the second regional server; and performing at least one of the following operations on the first event signal at the third computation time point at the end of the cycle time period:
determining an intersection of the map boundary of the virtual sub-world and the unidirectional transfer event based on an event description vector in the first event signal;
determining a second state of a virtual element based on the event description vector in the first event signal and a first state of the virtual element in the virtual sub-world; and
deducting, based on first virtual energy that needs to be consumed in the second regional server during computation of the first event signal, virtual energy corresponding to the unidirectional transfer event, to determine second virtual energy corresponding to the unidirectional transfer event.

In some arrangements, the at least two regional servers may each correspond to a virtual sub-world in the virtual world, the at least one event may include a first event, the at least one event signal may include a first event signal, and the first event may be a spreading event.

The computing each of the at least one event signal may include at least one of the following:
broadcasting the spreading event corresponding to the first event signal at the third computation time point at the end of the cycle time period; and
evenly dividing, at the third computation time point at the end of the cycle time period, based on a quantity of at least two propagation directions corresponding to the spreading event, virtual energy corresponding to the spreading event into equal parts satisfying the quantity, to determine third virtual energy corresponding to the spreading event.

In some arrangements, the at least two regional servers may further include a third regional server logically connected to the second regional server, and the third regional server and the first regional server may be different regional servers. The method may further include: generating at least one second event signal of the at least one event based on the event running result of each of the at least one event signal in the second regional server; and transmitting the at least one second event signal to the third regional server at a fourth computation time point, the fourth computation time point being a computation time point determined based on the second cycle.

In some arrangements, the at least one event may include a second event, and the second event may be a unidirectional transfer event. The method further includes: determining a third regional server based on a single propagation direction corresponding to the unidirectional transfer event, and transmitting at least one second event signal to the third regional server at a fourth computation time point.

In some arrangements, the at least one event may include a second event, and the second event may be a spreading event. The method further includes: determining at least two third regional servers based on at least two propagation directions corresponding to the spreading event, and transmitting at least one second event signal to the third regional servers at a fourth computation time point. For descriptions of the virtual world-based information transfer method performed by the second regional server in this arrangement, refer to descriptions corresponding to the second regional server in the foregoing arrangement. Details are not described herein again in this arrangement.

The virtual world-based information transfer method in this arrangement is described by using an example in which the method is applied to a cloud game scenario. In the cloud game scenario, a virtual world is a cloud game world, and a server configured to deploy the cloud game world is a cloud server. A regional server is a cloud game regional server. A first regional server is a first cloud game regional server, a second regional server is a second cloud game regional server, and a third regional server is a third cloud game regional server. Cloud game regional servers may be logically connected to each other by using a message forwarding node. A plurality of computation units in a cloud game regional server may be a plurality of parallel computing cores in a GPU in the cloud game regional server.

An event may be a cloud game event, and may be described by using an event attribute of the cloud game event, a cloud game regional server in which the event is located, a logical position in the cloud game regional server, and a generation moment in the cloud game regional server. In one arrangement, a spreading event may be an event that needs to be broadcast or notified in a cloud game, for example, a player obtains a reward, or a player wins a competition champion. A unidirectional transfer event may be an event in the cloud game and in which a single propagation direction and a termination condition are set. For example, a virtual object controlled by a player enters a world map of a cloud game regional server, and a virtual item appears in the world map of the cloud game world.

In the cloud game scenario, the cloud server configured to deploy the cloud game world may include at least two cloud game regional servers, and the at least two cloud game regional servers include a first cloud game regional server and a second cloud game regional server that are logically connected. Operations of the virtual world-based information transfer method provided in this arrangement are briefly described as follows:

Operation S11: The first cloud game regional server generates at least one event signal of at least one cloud game event at a first computation time point.

Operation S12: The first cloud game regional server transmits the at least one event signal to the second cloud game regional server at a second computation time point, the second computation time point being a next computation time point following the first computation time point determined based on a first cycle, and the first cycle being a computation cycle corresponding to the first cloud game regional server.

Operation S13: The second cloud game regional server receives the at least one event signal.

Operation S14: The second cloud game regional server determines a cycle time period within which a receiving moment of the at least one event signal falls, the receiving moment being a moment within the cycle time period, and a length of the cycle time period being equal to a second cycle.

Operation S15: The second cloud game regional server computes each of the at least one event signal at a third computation time point at the end of the cycle time period, to obtain an event running result of each of the at least one event signal in the second cloud game regional server, the third computation time point being a computation time point determined based on the second cycle, and the second cycle being a computation cycle corresponding to the second cloud game regional server.

In one arrangement, the at least two cloud game regional servers may each correspond to a cloud game sub-world in the cloud game world, the at least one event may include a first event, the at least one event signal may include a first event signal, and the first event may be a unidirectional transfer event.

For example, the second cloud game regional server may determine a map boundary of a cloud game sub-world corresponding to the second cloud game regional server. In operation S15, at least one of the following operations may be performed on the first event signal at the third computation time point at the end of the cycle time period:
1. The second cloud game regional server determines an intersection of the map boundary of the cloud game sub-world and the unidirectional transfer event based on an event description vector in the first event signal. In one arrangement, the second cloud game regional server determines the intersection of the map boundary of the cloud game sub-world and the unidirectional transfer event based on an event attribute and a logical position in the event description vector. Then, the intersection may be finally displayed on a terminal of a user after being rendered.
2. The second cloud game regional server determines a second state of a virtual element based on the event description vector in the first event signal and a first state of the virtual element in the cloud game sub-world. In one arrangement, the second cloud game regional server determines the second state of the virtual element based on the event attribute and the logical position in the event description vector and the first state of the virtual element in the cloud game sub-world.
3. The second cloud game regional server deducts, based on first virtual energy that needs to be consumed in the second cloud game regional server during computation of the first event signal, virtual energy corresponding to the unidirectional transfer event, to determine second virtual energy corresponding to the unidirectional transfer event.

In one arrangement, the at least two cloud game regional servers may each correspond to a cloud game sub-world in the cloud game world, the at least one event may include a first event, the at least one event signal may include a first event signal, and the first event may be a spreading event.

For example, operation S15 of the second cloud game regional server computing each of the at least one event signal at a third computation time point at the end of the cycle time period, to obtain an event running result of each of the at least one event signal in the second cloud game regional server may include at least one of the following operations:
1. The second cloud game regional server broadcasts the spreading event corresponding to the first event signal at the third computation time point at the end of the cycle time period.
2. The second cloud game regional server evenly divides, at the third computation time point at the end of the cycle time period, based on a quantity of at least two propagation directions corresponding to the spreading event, virtual energy corresponding to the spreading event into equal parts satisfying the quantity, to determine third virtual energy corresponding to the spreading event.

The at least two cloud game regional servers further include a third cloud game regional server logically connected to the second cloud game regional server, and the third cloud game regional server and the first cloud game regional server are different cloud game regional servers. The method further includes:

Operation S16: The second cloud game regional server generates at least one second event signal of the at least one event based on the event running result of each of the at least one event signal in the second cloud game regional server.

Operation S17: The second cloud game regional server transmits the at least one second event signal to the third cloud game regional server at a fourth computation time point, the fourth computation time point being a computation time point determined based on the second cycle.

In one arrangement, the at least one event may include a second event, and the second event may be a unidirectional transfer event. The second cloud game regional server may determine a third cloud game regional server based on a single propagation direction corresponding to the unidirectional transfer event, and transmit the at least one second event signal to the third cloud game regional server at the fourth computation time point. In one arrangement, the at least one event may include a second event, and the second event may be a spreading event. The second cloud game regional server may determine at least two third cloud game regional servers based on at least two propagation directions corresponding to the spreading event, and transmit the at least one second event signal to the third cloud game regional servers at the fourth computation time point.

Using the second cloud game regional server as an example, the second cloud game regional server may include at least two computation units divided based on the cloud game sub-world corresponding to the second cloud game regional server, the at least two computation units may include a first computation unit and a second computation unit that are logically connected, and the first computation unit and the second computation unit may be configured to compute the same event signal. The method may further include:

Operation S21: The first computation unit generates a third event signal of a third event at a fifth computation time point. Operation S22: The first computation unit transmits the third event signal to the second computation unit at the fifth computation time point. Operation S23: The second computation unit obtains the third event signal at a sixth computation time point. Operation S24: The second computation unit computes the third event signal at the sixth computation time point, to obtain an event running result of the third event signal in the second computation unit.

The fifth computation time point may be a computation time point determined based on the second cycle, and the sixth computation time point may be a next computation time point following the fifth computation time point determined based on the second cycle.

In one arrangement, the second cloud game regional server may be provided with a shared storage region. The shared storage region may be a storage region shared by the at least two computation units, and each of the at least two computation units corresponds to a sub-region in the shared storage region. In this arrangement, the shared storage region may be a storage region in cloud storage or the second cloud game regional server.

For example, the first computation unit may write the third event signal into a sub-region corresponding to the second computation unit in the shared storage region at the fifth computation time point; and the second computation unit may read, at the sixth computation time point, the third event signal from the sub-region corresponding to the second computation unit in the shared storage region.

In one arrangement, the third event may include a unidirectional transfer event. The second computation unit may determine a sub-map boundary of the second computation unit in the cloud game sub-world corresponding to the second cloud game regional server; and the second computation unit may compute the third event signal at the sixth computation time point based on an event description vector in the third event signal, to determine an intersection of the sub-map boundary and the unidirectional transfer event.

In one arrangement, the third event includes a spreading event. The second computation unit may broadcast the spreading event corresponding to the third event signal at the sixth computation time point.

In one arrangement, the at least two computation units in the second cloud game regional server may be divided based on at least one of the following:
1. a type of data that needs to be processed in the cloud game sub-world corresponding to the second cloud game regional server; 2. space of the cloud game sub-world corresponding to the second cloud game regional server; and 3. a type of a virtual element included in the cloud game sub-world corresponding to the second cloud game regional server.

Accordingly, the virtual world-based information transfer methods provided in arrangements described herein may be applied to a cloud technology scenario such as a cloud game, and a boundless and infinite cloud game world can be constructed.

For example, FIG. 16 is a block diagram of an example structure of a virtual world-based information transfer apparatus according to one or more aspects described herein. The virtual world-based information transfer apparatus 700 includes:
a processing module 710, configured to perform operation 620 in the arrangement of FIG. 14; and
a transceiver module 720, configured to perform operation 640 in the arrangement of FIG. 14, the first computation time point and the second computation time point being adjacent computation time points determined based on a first cycle, and the first cycle being a computation cycle corresponding to the first regional server; and the at least one event signal being configured for being computed by the second regional server at a third computation time point after the at least one event signal is received by the second regional server, to obtain an event running result of each of the at least one event signal in the second regional server, the third computation time point is being a computation time point determined based on a second cycle, and the second cycle is being a computation cycle corresponding to the second regional server.

For example, FIG. 17 is a block diagram of an example structure of a virtual world-based information transfer apparatus according to one or more aspects described herein. The virtual world-based information transfer apparatus 800 includes:
a transceiver module 810, configured to perform operation 660 in the arrangement of FIG. 15; and
a processing module 820, configured to perform operation 680 in the arrangement of FIG. 15, the third computation time point being a computation time point determined based on a second cycle, and the second cycle being a computation cycle corresponding to the second regional server;
the at least one event signal being generated by the first regional server at a first computation time point and transmitted to the second regional server at a second computation time point; and the first computation time point and the second computation time point being adjacent computation time points determined based on a first cycle, and the first cycle being a computation cycle corresponding to the first regional server.

In some arrangements, the processing module 820 is configured to perform operation 320 and operation 340 in the arrangement of FIG. 9, the receiving moment being a moment within the cycle time period, and a length of the cycle time period being equal to the second cycle.

In some arrangements, the at least two regional servers each correspond to a virtual sub-world in the virtual world, the at least one event includes a first event, the at least one event signal includes a first event signal, and the first event is a unidirectional transfer event. The processing module 820 is configured to perform operation 341 in the arrangement in FIG. 9.

At least one of the following operations is performed on the first event signal at the third computation time point at the end of the cycle time period:
determining an intersection of the map boundary of the virtual sub-world and the unidirectional transfer event based on an event description vector in the first event signal;
determining a second state of a virtual element based on the event description vector in the first event signal and a first state of the virtual element in the virtual sub-world; and
deducting, based on first virtual energy that needs to be consumed in the second regional server during computation of the first event signal, virtual energy corresponding to the unidirectional transfer event, to determine second virtual energy corresponding to the unidirectional transfer event.

In some arrangements, the event description vector in the first event signal includes an event attribute of the first event and a logical position corresponding to the first event. The processing module 820 is configured to:
determine the intersection of the map boundary of the virtual sub-world and the unidirectional transfer event based on the event attribute and the logical position in the event description vector; and
determine the second state of the virtual element based on the event attribute and the logical position in the event description vector and the first state of the virtual element in the virtual sub-world.

In some arrangements, the at least two regional servers each correspond to a virtual sub-world in the virtual world, the at least one event includes a first event, the at least one event signal includes a first event signal, and the first event is a spreading event. The processing module 820 is configured to perform operation 342 and operation 344 in the arrangement in FIG. 9.

In some arrangements, the at least two regional servers further include a third regional server logically connected to the second regional server, and the third regional server and the first regional server are different regional servers. The processing module 820 is further configured to perform operation 420 and operation 440 in the arrangement of FIG. 10, the fourth computation time point being a computation time point determined based on the second cycle.

In some arrangements, the at least one event includes a second event, and the second event is a unidirectional transfer event. The processing module 820 is configured to perform operation 442 in the arrangement of FIG. 11.

In some arrangements, the at least one event includes a second event, and the second event is a spreading event. The processing module 820 is configured to perform operation 444 in the arrangement in FIG. 11.

In some arrangements, the second regional server includes at least two computation units divided based on the virtual sub-world corresponding to the second regional server, the at least two computation units include a first computation unit and a second computation unit that are logically connected, and the first computation unit and the second computation unit are configured to compute the same event signal. The processing module 820 includes a first computation unit and a second computation unit.

In some arrangements, the first computation unit is configured to perform operation 520 and operation 540 in the arrangement of FIG. 12.

In some arrangements, the second computation unit is configured to perform operation 560 and operation 580 in the arrangement of FIG. 12.

The fifth computation time point is a computation time point determined based on the second cycle, and the sixth computation time point is a next computation time point following the fifth computation time point determined based on the second cycle.

In some arrangements, the second regional server is provided with a shared storage region. The shared storage region is a storage region in which at least two computation units are shared, and each of the at least two computation units corresponds to a sub-region in the shared storage region.

In some arrangements, the first computation unit is configured to write, at the fifth computation time point, the third event signal into a sub-region corresponding to the second computation unit in the shared storage region.

In some arrangements, the second computation unit is configured to read, at the sixth computation time point, the third event signal from the sub-region corresponding to the second computation unit in the shared storage region.

In some arrangements, the third event includes a unidirectional transfer event. The second computation unit is configured to perform operation 581 and operation 583 in the arrangement of FIG. 13.

In some arrangements, the third event includes a spreading event. The second computation unit is configured to perform operation 582 in the arrangement of FIG. 13.

In some arrangements, the at least two computation units in the second regional server are divided based on at least one of the following: a type of data that needs to be processed in the virtual sub-world corresponding to the second regional server; space of the virtual sub-world corresponding to the second regional server; and a type of a virtual element included in the virtual sub-world corresponding to the second regional server.

For specific descriptions in one or more arrangements of the foregoing provided virtual world-based information transfer apparatus, refer to the foregoing descriptions on the virtual world-based information transfer methods. Details are not described herein again. The modules of the foregoing apparatus may be all or partially implemented by software, hardware, and a combination thereof. The modules may be embedded in or independent of a processor of a computer device in the form of hardware, or may be stored in a memory of the computer device in the form of software, so that the processor invokes to perform operations corresponding to the modules.

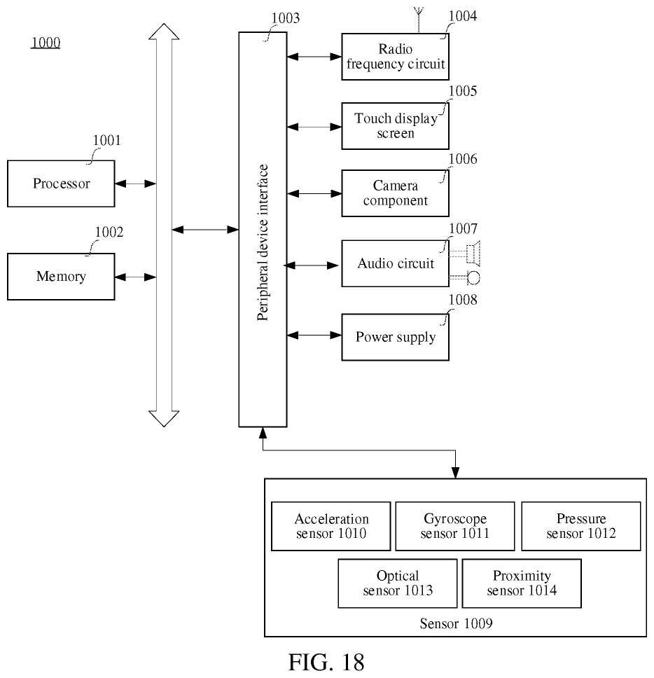

FIG. 18 is a block diagram of an example structure of a computer device according to one or more aspects described herein.

The computer device 1000 may be a portable mobile terminal, for example, a smart phone, a tablet computer, a Moving Picture Experts Group Audio Layer III (MP3) player, or a Moving Picture Experts Group Audio Layer IV (MP4) player. The computer device 1000 may also be referred to as another name such as user equipment or a portable terminal.

Generally, the computer device 1000 includes a processor 1001 and a memory 1002.

The processor 1001 may include one or more processing cores, for example, a 4-core processor or an 8-core processor. The processor 1001 may be implemented in at least one hardware form among a digital signal processor (DSP), a field programmable gate array (FPGA), and a programmable logic array (PLA). The processor 1001 may alternatively include a main processor and a coprocessor. The main processor is a processor configured to process data in an awake state, and is also referred to as a central processing unit (CPU). The coprocessor is a low power consumption processor configured to process the data in a standby state. In some arrangements, the processor 1001 may be integrated with a graphics processing unit (GPU). The GPU is configured to render and draw content that needs to be displayed on a display screen. In some arrangements, the processor 1001 may further include an artificial intelligence (AI) processor. The AI processor is configured to process computing operations related to machine learning.

The memory 1002 may include one or more computer-readable storage media. The computer-readable storage medium may be tangible and non-transient. The memory 1002 may further include a high-speed random access memory and a nonvolatile memory, for example, one or more disk storage devices or flash storage devices. In some arrangements, the non-transitory computer-readable storage medium in the memory 1002 is configured to store at least one instruction. The at least one instruction is configured for being executed by the processor 1001 to implement the virtual world-based information transfer methods in arrangements described herein.

In some arrangements, the computer device 1000 may include a peripheral device interface 1003 and at least one peripheral device. Specifically, the peripheral device includes at least one of a radio frequency circuit 1004, a touch display screen 1005, a camera 1006, an audio circuit 1007, and a power supply 1008. The peripheral device interface 1003 may be configured to connect the at least one peripheral related to input/output (I/O) to the processor 1001 and the memory 1002. In some arrangements, the processor 1001, the memory 1002, and the peripheral device interface 1003 are integrated on a same chip or circuit board. In some other arrangements, any one or two of the processor 1001, the memory 1002, and the peripheral device interface 1003 may be implemented on a single chip or circuit board, which is not limited in arrangements. The radio frequency circuit 1004 is configured to receive and transmit radio frequency (RF) signals, and is also referred to as an electromagnetic signal. The radio frequency circuit 1004 communicates with a communication network and another communication device through the electromagnetic signal. The radio frequency circuit 1004 may further include a circuit related to near field communication (NFC). The touch display screen 1005 is configured to display a user interface (UI). The UI may include a graph, text, an icon, a video, and any combination thereof. The camera component 1006 is configured to capture images or videos. In some arrangements, the camera component 1006 includes a front-facing camera and a rear-facing camera. The audio circuit 1007 is configured to provide an audio interface between a user and the computer device 1000. The audio circuit 1007 may include a microphone and a speaker. The microphone is configured to acquire sound waves of a user and an environment, and convert the sound waves into an electrical signal to input to the processor 1001 for processing, or input to the radio frequency circuit 1004 for implementing voice communication. The power supply 1008 is configured to supply power to various components in the computer device 1000. The power supply 1008 may be an alternating current, a direct current, a primary battery, or a rechargeable battery.

In some arrangements, the computer device 1000 further includes one or more sensors 1009. The one or more sensors 1009 include but are not limited to an acceleration sensor 1010, a gyroscope sensor 1011, a pressure sensor 1012, an optical sensor 1013, and a proximity sensor 1014.

The acceleration sensor 1010 may detect a magnitude of acceleration on three coordinate axes of a coordinate system established by the computer device 1000. The gyroscope sensor 1011 may detect a body direction and a rotation angle of the computer device 1000. The gyroscope sensor 1011 may cooperate with the acceleration sensor 1010 to acquire 3D actions performed by a user on the computer device 1000. The pressure sensor 1012 may be disposed at a side frame of the computer device 1000 and/or a lower layer of the touch display screen 1005, to detect a holding signal of a user on the computer device 1000, and/or control an operable control on the UI interface according to a pressure operation performed by the user on the touch display screen 1005. The optical sensor 1013 is configured to acquire ambient light intensity. In another arrangement, the processor 1001 may further dynamically adjust a camera parameter of the camera component 1006 according to the ambient light intensity collected by the optical sensor 1013. The proximity sensor 1014, also referred to as a distance sensor, is generally disposed on the front panel of the computer device 1000. The proximity sensor 1014 is configured to acquire a distance between the user and the front surface of the computer device 1000.

A person skilled in the art may understand that the example structure shown in FIG. 18 does not constitute a limitation to the computer device 1000, and the computer device 1000 may include more components or fewer components than those shown in the figure, or some components may be combined, or a different component deployment may be used.

In an exemplary arrangement, Aspects described herein provide a chip. The chip includes a programmable logic circuit and/or program instructions. When the chip runs on a computer device, the chip is configured to implement the virtual world-based information transfer method according to the foregoing method arrangements.

Aspects described herein further provide a computer-readable storage medium. The computer-readable storage medium has a computer program stored thereon, and the computer program is loaded and executed by a processor to implement the virtual world-based information transfer method according to the foregoing method arrangements. Aspects described herein provide a computer program product or a computer program. The computer program product or the computer program includes computer instructions, and the computer instructions are stored in a computer-readable storage medium. A processor of a computer device reads the computer instructions from the computer-readable storage medium, and executes the computer instructions, so that the processor of the computer device loads and executes the computer instructions to implement the virtual world-based information transfer method according to the foregoing method arrangements.

The sequence numbers of the foregoing arrangements described herein are merely for description purpose but do not imply the preference among the arrangements.

A person of ordinary skill in the art may understand that all or some of the operations of the foregoing arrangements may be implemented by hardware, or may be implemented by a program instructing related hardware. The program may be stored in a computer-readable storage medium. The computer-readable storage medium may be a read-only memory, a magnetic disk, an optical disc, or the like. A person skilled in the art may be aware that in the foregoing one or more examples, functions described in arrangements of described herein may be implemented by using hardware, software, firmware, or any combination thereof. When implemented by using software, the functions may be stored in a computer-readable medium or transmitted as one or more instructions or code in a computer-readable medium. The computer-readable medium includes a computer storage medium and a communication medium. The communication medium includes any medium that enables a computer program to be transmitted from one place to another. The storage medium may be any available medium accessible to a general-purpose or a dedicated computer.

What is claimed is:

1. An electronic virtual world-based information transfer method using a server configured to deploy a virtual world comprising at least two regional servers, the at least two regional servers comprising a first regional server and a second regional server that are logically connected to one another, the method comprising:
generating, by the first regional server deploying the virtual world, at least one event signal of at least one event at a first computation time point;
transmitting, by the first regional server, the at least one event signal to the second regional server at a second computation time point, the second computation time point being a next computation time point following the first computation time point determined based on a first cycle, the first cycle being a computation cycle corresponding to the first regional server;
receiving, by the second regional server, the at least one event signal; and
computing, by the second regional server, the at least one event signal at a third computation time point, to obtain an event running result of each of the at least one event signal in the second regional server, the third computation time point being a computation time point determined based on a second cycle, and the second cycle being a computation cycle corresponding to the second regional server, the first and second regional servers using different clocks.

2. The method according to claim 1, wherein the computing, by the second regional server, the at least one event signal at a third computation time point, to obtain an event running result of each of the at least one event signal in the second regional server comprises:
determining, by the second regional server, a cycle time period within which a receiving moment of the at least one event signal falls, the receiving moment being a moment within the cycle time period, and a length of the cycle time period being equal to the second cycle; and
computing, by the second regional server, each of the at least one event signal at the third computation time point at the end of the cycle time period, to obtain the event running result of each of the at least one event signal in the second regional server.

3. The method according to claim 2, wherein the at least two regional servers each correspond to a virtual sub-world in the virtual world, the at least one event comprises a first event, the at least one event signal comprises a first event signal, and the first event is a unidirectional transfer event; and
wherein the computing, by the second regional server, each of the at least one event signal at the third computation time point at the end of the cycle time period, to obtain the event running result of each of the at least one event signal in the second regional server comprises:
determining, by the second regional server, a map boundary of a virtual sub-world corresponding to the second regional server; and
performing, by the second regional server, at least one of the following operations on the first event signal at the third computation time point at the end of the cycle time period:
determining, by the second regional server, an intersection of the map boundary of the virtual sub-world and the unidirectional transfer event based on an event description vector in the first event signal;
determining, by the second regional server, a second state of a virtual element based on the event description vector in the first event signal and a first state of the virtual element in the virtual sub-world; and
deducting, by the second regional server based on first virtual energy that needs to be consumed in the second regional server during computation of the first event signal, virtual energy corresponding to the unidirectional transfer event, to determine second virtual energy corresponding to the unidirectional transfer event.

4. The method according to claim 3, wherein the event description vector in the first event signal comprises an event attribute of the first event and a logical position corresponding to the first event;
wherein the determining, by the second regional server, an intersection of the map boundary of the virtual sub-world and the unidirectional transfer event based on an event description vector in the first event signal comprises:
determining, by the second regional server, the intersection of the map boundary of the virtual sub-world and the unidirectional transfer event based on the event attribute and the logical position in the event description vector; and
wherein the determining, by the second regional server, a second state of a virtual element based on the event description vector in the first event signal and a first state of the virtual element in the virtual sub-world comprises:
determining, by the second regional server, the second state of the virtual element based on the event attribute and the logical position in the event description vector and the first state of the virtual element in the virtual sub-world.

5. The method according to claim 2, wherein the at least two regional servers each correspond to a virtual sub-world in the virtual world, the at least one event comprises a first event, the at least one event signal comprises a first event signal, and the first event is a spreading event; and
wherein the computing, by the second regional server, each of the at least one event signal at the third computation time point at the end of the cycle time period, to obtain the event running result of each of the at least one event signal in the second regional server comprises at least one of the following operations:
broadcasting, by the second regional server, the spreading event corresponding to the first event signal at the third computation time point at the end of the cycle time period; and
evenly dividing, by the second regional server at the third computation time point at the end of the cycle time period, based on a quantity of at least two propagation directions corresponding to the spreading event, virtual energy corresponding to the spreading event into equal parts satisfying the quantity, to determine third virtual energy corresponding to the spreading event.

6. The method according to claim 2, wherein the at least two regional servers further comprise a third regional server logically connected to the second regional server, and the third regional server and the first regional server being different regional servers, the method further comprising:
generating, by the second regional server, at least one second event signal of the at least one event based on the event running result of each of the at least one event signal in the second regional server; and
transmitting, by the second regional server, the at least one second event signal to the third regional server at a fourth computation time point, the fourth computation time point being a computation time point determined based on the second cycle.

7. The method according to claim 6, wherein the at least one event comprises a second event, and the second event is a unidirectional transfer event; and
wherein the transmitting, by the second regional server, the at least one second event signal to the third regional server at a fourth computation time point comprises:
determining, by the second regional server, the third regional server based on a single propagation direction corresponding to the unidirectional transfer event, and transmitting the at least one second event signal to the third regional server at the fourth computation time point.

8. The method according to claim 6, wherein the at least one event comprises a second event, and the second event is a spreading event; and
wherein the transmitting, by the second regional server, the at least one second event signal to the third regional server at a fourth computation time point comprises:
determining, by the second regional server, at least two third regional servers based on at least two propagation directions corresponding to the spreading event, and transmitting the at least one second event signal to the third regional servers at the fourth computation time point.

9. The method according to claim 3, wherein the second regional server comprises at least two computation units divided based on the virtual sub-world corresponding to the second regional server, the at least two computation units comprise a first computation unit and a second computation unit that are logically connected, and the first computation unit and the second computation unit are configured to compute a same event signal, the method further comprising:
generating, by the first computation unit, a third event signal of a third event at a fifth computation time point;
transmitting, by the first computation unit, the third event signal to the second computation unit at the fifth computation time point;
obtaining, by the second computation unit, the third event signal at a sixth computation time point; and
computing, by the second computation unit, the third event signal at the sixth computation time point, to obtain an event running result of the third event signal in the second computation unit,
the fifth computation time point being a computation time point determined based on the second cycle, and the sixth computation time point being a next computation time point following the fifth computation time point determined based on the second cycle.

10. The method according to claim 9, wherein the second regional server is provided with a shared storage region, the shared storage region is a storage region shared by the at least two computation units, and each of the at least two computation units corresponds to a sub-region in the shared storage region;
the transmitting, by the first computation unit, the third event signal to the second computation unit at the fifth computation time point comprises:
writing, by the first computation unit at the fifth computation time point, the third event signal into a sub-region corresponding to the second computation unit in the shared storage region; and
the obtaining, by the second computation unit, the third event signal at a sixth computation time point comprises:
reading, by the second computation unit at the sixth computation time point, the third event signal from the sub-region corresponding to the second computation unit in the shared storage region.

11. The method according to claim 9, wherein the third event comprises a unidirectional transfer event; and
the computing, by the second computation unit, the third event signal at the sixth computation time point, to obtain an event running result of the third event signal in the second computation unit comprises:
determining, by the second computation unit, a sub-map boundary of the second computation unit in the virtual sub-world corresponding to the second regional server; and
computing, by the second computation unit, the third event signal at the sixth computation time point based on an event description vector in the third event signal, to determine an intersection of the sub-map boundary and the unidirectional transfer event.

12. The method according to claim 9, wherein the third event comprises a spreading event; and
the computing, by the second computation unit, the third event signal at the sixth computation time point, to obtain an event running result of the third event signal in the second computation unit comprises:
broadcasting, by the second computation unit at the sixth computation time point, the spreading event corresponding to the third event signal.

13. The method according to claim 9, wherein the at least two computation units in the second regional server are divided based on at least one of the following:
a type of data that needs to be processed in the virtual sub-world corresponding to the second regional server;
space of the virtual sub-world corresponding to the second regional server; and
a type of a virtual element comprised in the virtual sub-world corresponding to the second regional server.

14. A virtual world-based information transfer system, comprising:
a first regional server providing at least a first portion of the virtual world; and
a second regional server providing at least a second portion of the virtual world, the second regional server logically connected to the first region server,
wherein the first regional server is configured to:
generate at least one event signal of at least one event at a first computation time point;
transmit the at least one event signal to the second regional server at a second computation time point, the second computation time point being a next computation time point following the first computation time point determined based on a first cycle, the first cycle being a computation cycle corresponding to the first regional server; and
wherein the second regional server is configured to:
receive the at least one event signal; and
compute the at least one event signal at a third computation time point, to obtain an event running result of each of the at least one event signal in the second regional server, the third computation time point being a computation time point determined based on a second cycle, and the second cycle being a computation cycle corresponding to the second regional server, the first and second regional servers using different clocks.

15. The system according to claim 14, wherein the computing, by the second regional server, the at least one event signal at a third computation time point, to obtain an event running result of each of the at least one event signal in the second regional server comprises:
determining, by the second regional server, a cycle time period within which a receiving moment of the at least one event signal falls, the receiving moment being a moment within the cycle time period, and a length of the cycle time period being equal to the second cycle; and
computing, by the second regional server, each of the at least one event signal at the third computation time point at the end of the cycle time period, to obtain the event running result of each of the at least one event signal in the second regional server.

16. The system according to claim 15, wherein the first regional server and the second regional server each correspond to a virtual sub-world in the virtual world, the at least one event comprises a first event, the at least one event signal comprises a first event signal, and the first event is a unidirectional transfer event; and
wherein the computing, by the second regional server, each of the at least one event signal at the third computation time point at the end of the cycle time period, to obtain the event running result of each of the at least one event signal in the second regional server comprises:
determining, by the second regional server, a map boundary of a virtual sub-world corresponding to the second regional server; and
performing, by the second regional server, at least one of the following operations on the first event signal at the third computation time point at the end of the cycle time period:
determining, by the second regional server, an intersection of the map boundary of the virtual sub-world and the unidirectional transfer event based on an event description vector in the first event signal;
determining, by the second regional server, a second state of a virtual element based on the event description vector in the first event signal and a first state of the virtual element in the virtual sub-world; and
deducting, by the second regional server based on first virtual energy that needs to be consumed in the second regional server during computation of the first event signal, virtual energy corresponding to the unidirectional transfer event, to determine second virtual energy corresponding to the unidirectional transfer event.

17. The system according to claim 16, wherein the event description vector in the first event signal comprises an event attribute of the first event and a logical position corresponding to the first event;
wherein the determining, by the second regional server, an intersection of the map boundary of the virtual sub-world and the unidirectional transfer event based on an event description vector in the first event signal comprises:
determining, by the second regional server, the intersection of the map boundary of the virtual sub-world and the unidirectional transfer event based on the event attribute and the logical position in the event description vector; and
wherein the determining, by the second regional server, a second state of a virtual element based on the event description vector in the first event signal and a first state of the virtual element in the virtual sub-world comprises:
determining, by the second regional server, the second state of the virtual element based on the event attribute and the logical position in the event description vector and the first state of the virtual element in the virtual sub-world.

18. A non-transitory computer-readable medium storing computer-readable instructions that, when executed, cause an electronic virtual world server to:
deploy a virtual world;
receive, from another electronic virtual world server, at least one event signal of at least one event; and
computing the at least one event signal at a first computation time point, to obtain an event running result of each of the at least one event signal in the electronic virtual world server, the first computation time point being a computation time point determined based on a first cycle, and the first cycle being a computation cycle corresponding to the electronic virtual world server,
wherein the at least one event signal is generated by the another electronic virtual world server at a second computation time point and transmitted to the electronic virtual world server at a third computation time point, the second computation time point and the third computation time point being adjacent computation time points determined based on a second cycle, the second cycle being a computation cycle corresponding to the another electronic virtual world server, and the second and third computation time points occurring before the first computation time point.

19. The non-transitory computer-readable medium according to claim 18, wherein the computing, by the electronic virtual world server, the at least one event signal at a first computation time point, to obtain an event running result of each of the at least one event signal comprises:
determining a cycle time period within which a receiving moment of the at least one event signal falls, the receiving moment being a moment within the cycle time period, and a length of the cycle time period being equal to the first cycle; and
computing each of the at least one event signal at the first computation time point at the end of the cycle time period, to obtain the event running result of each of the at least one event signal in the electronic virtual world server.

20. The non-transitory computer-readable medium according to claim 19, wherein the another electronic virtual world server and the electronic virtual world server each correspond to a virtual sub-world in the virtual world, the at least one event comprises a first event, the at least one event signal comprises a first event signal, and the first event is a unidirectional transfer event; and
wherein the computing, by the electronic virtual world server, each of the at least one event signal at the first computation time point at the end of the cycle time period, to obtain the event running result of each of the at least one event signal comprises:
determining a map boundary of a virtual sub-world corresponding to the electronic virtual world server; and
performing at least one of the following operations on the first event signal at the first computation time point at the end of the cycle time period:
determining an intersection of the map boundary of the virtual sub-world and the unidirectional transfer event based on an event description vector in the first event signal;
determining a second state of a virtual element based on the event description vector in the first event signal and a first state of the virtual element in the virtual sub-world; and
deducting, based on first virtual energy that needs to be consumed in the electronic virtual world server during computation of the first event signal, virtual energy corresponding to the unidirectional transfer event, to determine second virtual energy corresponding to the unidirectional transfer event.
